(19) United States
(12) Patent Application Publication
(10) Pub. No.: US 2009/0076911 A1
(43) Pub. Date: Mar. 19, 2009

(54) MOBILE COUPONS UTILIZING PEER TO PEER RANGING

(76) Inventors: Dang Minh Vo, San Diego, CA (US); Rajeev D. Rajan, San Diego, CA (US); Jose Ricardo Dos Santos, San Diego, CA (US); Kamran Moallemi, Del Mar, CA (US); Manuel E. Jaime, Solana Beach, CA (US); Michael James Koenig, Encinitas, CA (US)

Correspondence Address: QUALCOMM INCORPORATED, 5775 MOREHOUSE DR., SAN DIEGO, CA, 92121, US

(21) Appl. No.: 12/124,834

(22) Filed: May 21, 2008

Related U.S. Application Data
(60) Provisional application No. 60/945,120, filed on Jun. 20, 2007.

(51) Int. Cl. G06Q 30/00; G01S 3/02

(52) U.S. Cl. 705/14; 342/118

(57) ABSTRACT

Providing for distribution of a dynamic mobile coupon (DMC) based on verified peer-to-peer (P-P) ranging between two wireless devices is described herein. By way of example, a first device can form a wireless link with a mobile device and initiate P-P ranging. By analyzing signals sent over the wireless link, a distance between such devices can be determined. In addition, at least a minimum distance between such devices can be verified based on actions performed by the mobile device that require a minimum completion time. Based in part on this verified distance, a DMC can be issued to the mobile device. Accordingly, the subject disclosure provides for increased security for issuing the DMC and mitigation of device spoofing, by verifying a minimum distance to the mobile devices and conditioning issuance of the DMC on such verified distance.

### CLAIM OF PRIORITY UNDER 35 U.S.C. §119

The present Application for patent claims priority to Provisional Application No. 60/945,120 entitled METHOD AND APPARATUS FOR DELIVERING COUPONS BASED ON RANGING filed Jun. 20, 2007, and assigned to the assignee hereof and hereby expressly incorporated by reference herein.

### REFERENCE TO CO-PENDING APPLICATIONS FOR PATENT

The present application for patent is related to pending U.S. patent application Ser. No. 11/735,867 entitled VERIFIED DISTANCE RANGING filed Apr. 16, 2007, assigned to the assignee hereof and expressly incorporated by reference herein; and U.S. patent application Ser. No. 11/734,241 entitled DISTANCE-BASED SECURITY filed Apr. 11, 2007, assigned to the assignee hereof and expressly incorporated by reference herein.

### BACKGROUND

The following relates generally to a mobile operating environment, and more particularly to providing mobile coupons to a mobile device based on peer to peer ranging techniques.

In recent years, a variety of advancements has occurred in cellular communication technology and cellular communication devices. Some of the advancements, such as integration of camera and video recording technology onto such devices, incorporation of e-mail and short messaging services into mobile communication, and the like, involve software and/or hardware applications. These applications have added increased flexibility, processing power, communication capabilities, and so forth, to already popular communication devices (e.g., cellular telephones). As a result, such devices have become more popular in a consumer marketplace, motivating larger numbers of consumers to purchase such devices, or to upgrade to devices that include new applications and technologies.

One particular advancement of note in mobile communication is use of a mobile communication device in electronic commerce. For instance, various mechanisms to provide electronic payment can be implemented by a mobile device. Due to the portable nature of such devices, electronic payment can be utilized in conjunction with retail purchases at a retail store, for instance, as well as online purchases via the Internet. For instance, the mobile device can store or provide an interface to electronic forms of payment such as a credit card, debit card, and/or the like.

As commerce by way of mobile device expands, traditional sales and marketing efforts directed toward consumers increasingly leverage mobile communications. As a particular example, entities can distribute electronic coupons, providing value and/or information in conjunction with a commercial transaction, to consumer mobile devices. Such coupons can be distributed, for instance, via e-mail. The coupon can specify a particular value that can be redeemed in conjunction with a specified transaction. However, certain dynamic demographic information associated with a mobile device might not be fully leveraged utilizing such distribution techniques. For instance, sending a coupon to be redeemed at a particular store can be of low contemporaneous value if no such store is near to a recipient device. Accordingly, having particular dynamic information associated with consumer mobile devices can be helpful in influencing buying decisions and/or providing additional value to the consumer.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The subject disclosure provides for integrating peer to peer (P-P) ranging with providing a dynamic mobile coupon (DMC) to a mobile device. A first device can form a wireless link with the mobile device and initiate P-P ranging. Based on a distance determined from the P-P ranging, a DMC can be issued to the mobile device, providing value in conjunction with purchase of a product or service associated with the first device. As an example, such device can determine that the mobile device is outside of a commercial store associated with the device, and by issuing the DMC, attempt to attract a user of the device into the commercial store. It should be appreciated that a value of the DMC can be set upon issuance, and/or be generated/updated upon redemption. According to further aspects, the value can dynamically be adjusted, and displayed at the mobile device, based on time from issuance, change in the P-P determined distance, proximity to a competing device or entity, and so on. Accordingly, the subject disclosure provides for a flexible environment to issue and/or valuate a DMC based at least in part on P-P determined distance of an issuing and receiving device.

Also disclosed is a method of wireless communication between devices. The method comprises determining a distance between a first device and a mobile device. In addition, the method can include determining whether the distance is equal to or less than at least one distance threshold and associating a DMC with the mobile device based at least in part on the at least one distance threshold determination.

According to a further aspect, disclosed is an apparatus that provides a DMC to one or more wireless devices in a wireless communication environment. The apparatus can comprise a wireless interface that forms a wireless link with a mobile device and a ranging module that determines a distance between the mobile device and a host device. Further, the apparatus can comprise an authorization module that verifies the distance and a DMC issuance module that associates a DMC with the mobile device based on a comparison of the verified distance and at least one threshold distance.

According to one or more other aspects, provided is an apparatus configured to facilitate distribution or redemption of a DMC in a wireless environment. The apparatus can include a wireless interface that forms a wireless link with a mobile device and a ranging module that determines a distance between the mobile device and a host device. Furthermore, the apparatus can include an authorization module that verifies the distance and a DMC issuance module that associates a DMC with the mobile device based on a comparison of the verified distance and at least one threshold distance. Moreover, the apparatus can also include an application module configured to associate the DMC with a transaction.

According to an additional aspect, provided is an apparatus configured to provide distribution of a DMC in a wireless communication environment. The apparatus can comprise means for determining a distance between a first device and a mobile. Additionally, the apparatus can comprise means for determining whether the distance is equal to or less than at least one distance threshold and means for associating a DMC with the mobile device based at least in part on the distance threshold determination.

In addition to the foregoing, also disclosed is a computer program product configured to provide distribution of a DMC in a wireless communication environment. The computer program product can comprise a computer-readable medium containing at least one instruction for causing a computer to determine a distance between a first device and a mobile device. Furthermore, the computer-readable medium further contains at least one instruction for causing a computer to determine whether the distance is equal to or less than at least one distance threshold and associate a DMC with the mobile device based at least in part on the distance threshold determination.

According to one or more additional aspects, disclosed is a method of wireless communication between first and second devices. The method can comprise receiving a first signal over a wireless link pertaining to a DMC and transmitting a second signal from a first device to a second device, the second signal provides information in response to the first signal. Additionally, the method can comprise obtaining access to a DMC based at least in part on a distance between the first and second devices, wherein the distance is determined at least in part from the first signal and the information provided by the second signal.

According to a further aspect, provided is an apparatus that facilitates distribution of a DMC in a wireless environment. The apparatus can include a receiver that obtains a first signal via a wireless link and a transmitter that responds to the first signal with a second signal, the second signal provides information in response to the first signal. The apparatus can also include an interface module that obtains access to a DMC at a receiving mobile device based at least in part on a distance between the receiving mobile device and a DMC host device, the distance is determined at least in part from the first signal and the information provided by the second signal.

According to still another aspect, disclosed is a mobile device that facilitates distribution of a DMC in a wireless environment. The mobile device can comprise a receiver that obtains a first signal via a wireless link and a transmitter that responds to the first signal with a second signal, the second signal provides information in response to the first signal. Furthermore, the mobile device can comprise an interface module that obtains access to a DMC at a mobile device based at least in part on a distance between the mobile device and a DMC host device, the distance is determined at least in part from the first signal and the information provided by the second signal. In addition to the foregoing, the mobile device can comprise a user interface that facilitates at least outputting information pertinent to the DMC.

According to one or more other aspects, provided is an apparatus configured to facilitate distribution of a DMC in a wireless environment. The apparatus can include means for receiving a first signal over a wireless link and means for responding to the first signal with a second signal, the second signal provides information in response to the first signal. The apparatus can also include means for obtaining access to a DMC at a mobile device based at least in part on a distance between the mobile device and a DMC host device, the distance is determined at least in part from the first signal and the information provided by the second signal.

In addition to the foregoing, also provided is a computer program product to facilitate distribution of a DMC in a wireless environment. The computer program product can comprise a computer-readable medium containing at least one instruction for causing a computer to receive a first signal over a wireless link and respond to the first signal with a second signal, the second signal provides information in response to the first signal. Further, the computer-readable medium can further contain at least one instruction for causing a computer to obtain access to a DMC at a mobile device based at least in part on a distance between the mobile device and a DMC host device, the distance is determined at least in part from the first signal and the information provided by the second signal.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects can be employed and the described aspects are intended to include all such aspects and their equivalents.

### BRIEF DESCRIPTION OF THE DRAWINGS

FIG. 1 illustrates a block diagram of a sample dynamic mobile coupon (DMC) distribution system that utilizes peer-to-peer (P-P) ranging.

FIG. 2 depicts a block diagram of an example system that can distribute a DMC based at least in part on P-P determined distance to a mobile device.

FIG. 3 illustrates a block diagram of a sample DMC issuing device according to one or more aspects.

FIG. 4 depicts a block diagram of an example DMC application according to further aspects.

FIG. 5 illustrates a block diagram of an example system that facilitates receipt, use, and redemption of a DMC according to some aspects.

FIG. 6 depicts a block diagram of a sample mobile handset in accordance with aspects disclosed herein.

FIG. 7 illustrates a block diagram of an example system that provides a DMC in a commercial competition environment.

FIG. 8 depicts an example base station for determining secondary position or distance of a mobile device according to aspects

FIG. 9 illustrates a sample methodology for providing a DMC based on P-P ranging.

FIG. 10 depicts an example methodology for issuing, evaluating, and redeeming a DMC according to further aspects.

FIG. 11 illustrates an example methodology for receiving and utilizing a DMC in conjunction with P-P ranging.

FIG. 12 depicts an example methodology for facilitating secure communication for receiving and utilizing a DMC according to one or more aspects.

FIGS. 13 and 14 provide example block diagrams of systems that provide and utilize, respectively, DMCs based in part on P-P ranging according to some aspects.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more aspects.

The subject disclosure provides for issuing a dynamic mobile coupon (DMC) based at least in part on a distance between a receiving mobile device and an issuing device, determined by peer to peer (P-P) ranging. P-P ranging can be an effective, efficient, fast, and low power mechanism for determining distance between one or more wireless devices. Ranging systems in a mobile environment can often utilize base station triangulation, global position system (GPS) satellites and/or servers, or other established mechanisms. Such ranging can be slow and require high transmission/reception power due to relatively large distances (e.g., as compared with P-P device distances, at least in many instances) often associated with base station and/or satellite communication. Accordingly, P-P ranging can be a low cost, low power alternative to determining a distance between one wireless device and another wireless device.

A digital mobile coupon (DMCs) is an electronic application initiated by a sponsor and sent to a mobile device of a potential consumer and/or potential customer of the sponsor. The DMC can describe a product or service that the sponsor is promoting. The DMC also can indicate a value that a recipient can redeem in conjunction with sale, loan or lease, etc., of the product or service. For instance, a shoe manufacturer could send a DMC describing a particular brand of shoes, and offering a $5 discount in conjunction with purchase of a pair of the shoes. Similar to physical coupons (e.g., clipped out of a newspaper), DMCs often have restrictions that limit redemption, including but not limited to time of redemption, location of redemption, number of products the redeemable value can be applied to, and so on. Unlike some physical coupons, redemption of a DMC can optionally be limited to a particular mobile device or person associated with the mobile device. For instance, an electronic signature associated with a recipient mobile device can be required to redeem the DMC. Alternatively, identification (e.g., driver's license or other ID) of an individual can be required to redeem the DMC. Some DMCs, like many physical coupons, can be redeemed by any bearer, and thus can be traded amongst mobile devices and individuals.

Some sponsors coordinate with third party entities (hereinafter referred to as DMC distributors) to generate and distribute DMCs. The sponsor can provide rules that specify what products or services to associate with a coupon, what redemption restrictions to apply (e.g., time, location, number of products per coupon, number of coupons redeemable per purchase, etc.), a number of coupons to distribute, how to redeem a coupon, or the like. The DMC distributor then can charge a sponsor for the DMC distribution service. For instance, a DMC distributor might charge based on a number of DMCs distributed to potential consumer mobile devices, a number of DMCs that are redeemed, a percentage of value redeemed or of purchase price, or a suitable combination thereof.

Because some cost is associated with distribution of DMCs, whether a fee or a cost to create and maintain a DMC distribution system, and because over-distribution can create an impression of low desirability, sponsors can distribute DMCs selectively. Particularly, it can be desirable to provide a DMC to a consumer having some predisposition to purchase a product or service. Demographic studies often research purchase and spending habits of individuals. Further, purchasing histories, trendsetter recommendations, concurrent market factors, and other marketing principles can be employed in conjunction with distribution of DMCs. Accordingly, a sponsor can anticipate a likely return on investment associated with DMC distribution.

In some circumstances, proximity to a retail location can be pertinent to a consumer's purchasing decision. Thus, distribution of a DMC can be based at least in part on a determined distance between a wireless device and such location (or, e.g., an electronic device associated with the location) in comparison with at least one distance threshold. In some aspects, the distance threshold can be 10 meters or less, 20 meters or less, and/or 30 meters or less, or the like. According to further aspects, dynamic characteristics of the DMC can be dependent at least in part on the determined distance as compared with one or more distance thresholds (e.g., 50 cent discount when within 10 meters, 25 cent discount when within 20 meters, 10 cent discount when within 30 meters, or a suitable variation thereof).

According to one or more aspects disclosed herein, P-P ranging can be utilized to determine a distance between a mobile device and a location (e.g., retail location, retail device, distribution location, distribution device, etc.). As mentioned above, P-P ranging can often be much more efficient, utilize less power, and/or execute faster than base station and/or GPS location mechanisms. Thus, an issuing device can generate and distribute a DMC based at least in part on a distance to a recipient mobile device determined via an efficient, fast, and/or low-power link between such devices.

According to some aspects, particular P-P ranging techniques designed to mitigate device spoofing can be utilized in determining a distance between wireless devices. Spoofing occurs when a device attempts to intercept, receive, or otherwise obtain communication encoded for, and/or private to, another device. One method to mitigate spoofing is to authenticate the device based in part on actions (e.g., calculations, processing functions, wireless transmissions etc.) that can be performed only if such device is within a certain distance of a first device. Accordingly, if an authenticating device receives a response that indicates the responding device is outside of the certain distance (e.g., based on time to perform the actions), the responding device is classified as unauthorized. Thus, a DMC distributor can authorize a device by verifying a maximum distance to such device, and issue a DMC based at least in part on whether the maximum distance is within a distance threshold.

According to a particular aspect, DMC distribution can be in conjunction with P-P security. For instance, information pertinent to a distance between a first device and a mobile device can be transformed, encrypted, associated with a random generated number, or the like, to protect such data. The information can provide additional security in conjunction with authorizing a mobile device and limiting a spoofing range of an unauthorized device. Accordingly, P-P security can help mitigate device spoofing and interception of a DMC by an unauthorized device.

According to still one or more other aspects, a value of a DMC associated with a mobile device can be based at least in part on a distance between wireless devices determined by P-P ranging. Thus, for instance, if the distance is within a first predetermined distance threshold, a first value can be accorded to the DMC. If the distance is within a second predetermined distance threshold, a second value can be accorded the DMC, and so on.

According to a further aspect, a value of a DMC can be updated based on a dynamic parameter. As one example, the dynamic parameter can comprise a change in distance of the mobile device with respect to a DMC distribution entity, redemption entity, or another mobile device. Thus, as the distance increases the value could dynamically increase in a predetermined manner (and, e.g., up to a predetermined limit). As another example, as a time from issuance of a DMC increases, the value can increase or decrease. Moreover, if a user is determined to be a specified distance to one or more competing devices, the value can be updated further. Accordingly, various dynamic factors associated with the mobile device can be analyzed to increase or decrease the value of the DMC. According to at least one aspect, an adjustment in value can be presented to a device user at a receiving mobile device to provide additional motivation to redeem the DMC.

Various aspects of the disclosure are described below. It should be apparent that the teaching herein can be embodied in a wide variety of forms and that any specific structure and/or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented and/or a method practiced using any number of the aspects set forth herein. In addition, an apparatus can be implemented and/or a method practiced using other structure and/or functionality in addition to or other than one or more of the aspects set forth herein. As an example, many of the methods, devices, systems, and apparatuses described herein are described in the context of one or more mobile applications operating on at least one mobile device and establishing secure communication between such applications. One skilled in the art should appreciate that similar techniques could apply to other communication environments as well.

As used in this disclosure, the terms “component,” “system,” “module,” and the like are intended to refer to a computer-related entity, either hardware, software, software in execution, firmware, middle ware, microcode, and/or any combination thereof. For example, a component can be, but is not limited to being, a process running on a processor, a processor, an object, an executable, a thread of execution, a program, and/or a computer. One or more components can reside within a process and/or thread of execution and a component can be localized on one computer and/or distributed between two or more computers. Further, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal). Additionally, components of systems described herein can be rearranged and/or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general-purpose processor can be a microprocessor, but, in the alternative, the processor can be any suitable processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Additionally, at least one processor can comprise one or more modules operable to perform one or more of the steps and/or actions described herein.

Furthermore, various aspects are described herein in connection with a mobile communication device (or, e.g., a mobile device). A mobile communication device can also be called a system, a subscriber unit, a subscriber station, mobile station, mobile, mobile device, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

Moreover, various aspects or features described herein can be implemented as a method, apparatus, or article of manufacture using standard programming and/or engineering techniques. Further, the steps and/or actions of a method or algorithm described in connection with the aspects disclosed herein can be embodied directly in hardware, in a software module executed by a processor, or in a combination of the two. Additionally, in some aspects, the steps and/or actions of a method or algorithm can reside as at least one or any combination or set of codes and/or instructions on a machine readable medium and/or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction, and/or data.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should be construed to mean “one or more” unless specified otherwise or clear from context to be directed to a singular form.

As used herein, the terms to “infer” or “inference” refer to the process of reasoning about or inferring states of a system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

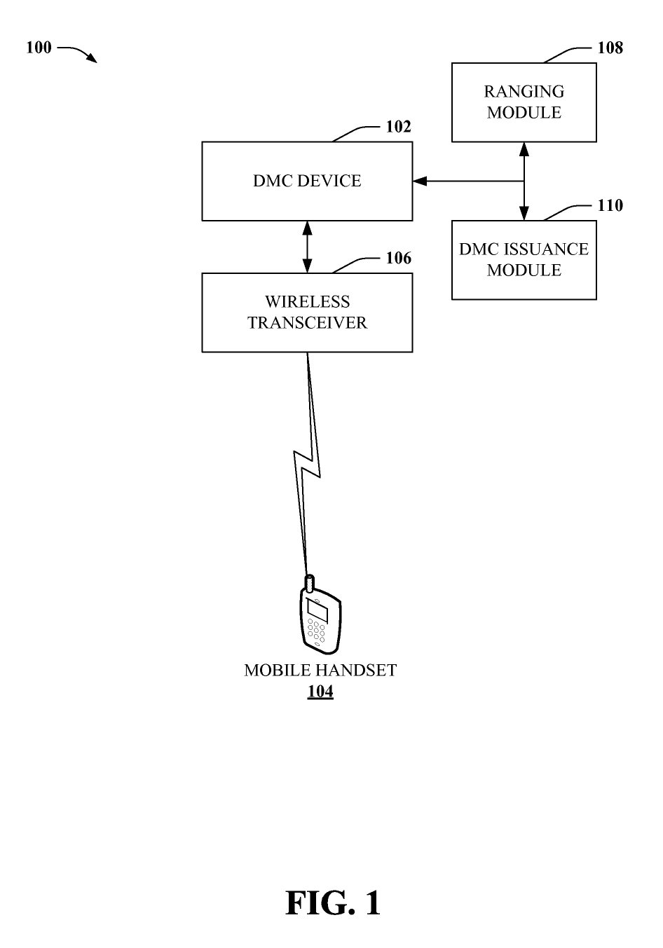

FIG. 1 illustrates an exemplary block diagram of a system 100 that provides distribution of DMCs based at least in part on use of a P-P ranging function. The P-P ranging function can determine and verify a distance, comprising at least a minimum distance, between a recipient device (104) and an issuing device (102, 106). Accordingly, system 100 can mitigate spoofing in distributing a DMC to a mobile device 104, by authorizing a receiving mobile handset 104 in part based on verified distance.

P-P ranging can utilize a wireless link between two wireless devices (104, 106) to determine and verify distance between such devices (104, 106). System 100 includes a DMC device 102 that can generate and issue a DMC to one or more mobile devices (104). The DMC device 102 can comprise an electronic device (e.g., a mobile device, a wireless transceiver, an electronic cash register, a wireless transceiver linked with the electronic cash register, and so on) associated with a sponsor of the DMC, a store selling a product identified by the DMC, a third-party DMC distributor, and so on.

As one non-limiting example of the foregoing, the DMC device (102, 106) could comprise a wireless beacon (e.g., a transceiver) configured to exchange data directly and/or indirectly with a mobile device (104). For instance, the DMC device (102, 106) can be a wireless beacon, a stand-alone wireless transceiver, a networked wireless transceiver, etc., utilized by a merchant. The DMC device (102, 106) can employ a peer to peer physical layer, at least in part, to conduct remote communication. Nearby mobile devices can be identified by conducting wireless data exchange (e.g., utilizing a suitable radio frequency, a licensed cellular frequency, an unlicensed frequency, or other suitable wireless data exchange) with such devices. Based on at least one criterion, as described herein, the DMC device 102 can provide a DMC or an indication of such DMC to the mobile device (104) (e.g., based on distance to a mobile device, distance to a retail location, distance between the mobile device and the retail location, based on a flag set at the mobile device indicating that data from the merchant can be received, or that a DMC can be received, etc.).

Thus, in some aspects, DMC device 102 can utilize a wireless transceiver 106 to exchange signals with other wireless devices (104). In some aspects, distance between devices (104, 106) can be determined by processing at least one first signal sent from the wireless transceiver 106 to the mobile handset 104. Alternatively, or in addition, system 100 can determine distance between devices (104, 106) by processing at least one second signal sent from the mobile device 104 to the wireless transceiver 106. Specifically, an elapsed time between transmitting the signal(s) and receiving the signal(s) and a speed of propagation of such signals (e.g., speed of light in a suitable medium) can be utilized to calculate distance between such devices (104, 106). This P-P ranging technique is referred herein as signal ranging.

In other aspects, P-P ranging can employ a two-way message exchange mechanism to measure relative distance between two devices (104, 106). For instance, wireless transceiver 106 can send a ranging packet to the mobile handset 104. Mobile handset 104 can then send a reply packet back to the wireless transceiver 106. A time between sending the ranging packet and receiving the reply packet is the total round trip time.

Included within the reply packet is a turnaround time or processing time associated with sending the reply packet. As utilized herein, the turnaround time is an elapsed time between a time that the mobile handset 104 receives the ranging packet and a time that the mobile handset 104 sends the reply packet. Wireless transceiver 106 can subtract the turnaround time from the total round trip time to determine propagation time of the packets, and along with propagation speed, the relative distance between the devices (104, 106). Specifically, the turnaround time can be subtracted from the total round-trip time, and the total round-trip distance can then be calculated. This P-P ranging technique is referred herein as round-trip ranging.

Ranging packets as discussed above can be generated by ranging module 108. Ranging module 108 can then provide the ranging packets to the DMC device 102 to be transmitted by wireless transceiver 106. In addition, ranging module 108 can contain logic to perform P-P distance determinations discussed above, or other distance determinations known in the art. (For example, utilizing a location of a mobile device and/or a host DMC device 102 obtained from global positioning system [GPS] or like satellite-based technology, or location determined from one or more mobile network base stations, or the like, to determine the distance between the mobile device and the host device.) In addition to determining distance, ranging module 108 can verify the distance determined to mitigate device spoofing.

One way that spoofing can occur in a P-P wireless link is by misreporting response signals. For instance, a spoofing device (not depicted) can receive a ranging packet sent by wireless transceiver 106. The spoofing device, when responding to the ranging packet, can misreport a turnaround time (e.g., reporting a longer than actual turnaround time) when sending a reply packet and/or can indicate that the reply packet was received earlier than it was actually received. In such circumstances, the wireless transceiver 106 could calculate an incorrect distance to the spoofing device (e.g., a lower than actual distance).

Ranging module 108 can verify a minimum distance from the wireless transceiver to a receiving device (104) by requiring the responding device (104) to perform actions requiring a minimum amount of time. According to some aspects, the minimum time can be substantially equivalent to a round trip propagation time. In such circumstances, it can be assumed that any processing or turnaround time required to send a reply packet is negligible compared with the round trip propagation time. In this manner, a distance that a spoofing device can spoof is limited to a distance corresponding to the round trip propagation time, or a threshold thereof (e.g., +/−10% of the round trip propagation time, where such threshold can correspond to a default or assumed turn around time).

According to at least one aspect, a ranging signal can comprise a random, pseudorandom, or deterministic sequence. For example, the ranging signal can comprise a sequence of pulses where each pulse has a randomly selected value. Thus, a proper response signal from the mobile device 104 will correspond to the sequence of the ranging signal. Ranging module 108 can associate a minimum time (e.g., to generate a response signal in accordance with the sequence) with a turn around time for the mobile device 104. A distance from the wireless transceiver 106 to the mobile device 104 can then be based off the round trip propagation time plus the minimum time to generate the response signal. A distance associated with a proper response signal can be verified to be at least a minimum distance corresponding to the propagation time plus the minimum time. A distance associated with an incorrect response signal can be rejected.

In some aspects, mobile device 104 can generate a response signal by operating on a ranging signal in accordance with a function that is based on a known signal response scheme. For instance, the mobile device 104 can utilize the function to operate on information represented by (e.g., included within) the ranging signal. The mobile device 104 then transmits the processed information to the wireless transceiver 106 that has knowledge of the signal response scheme, and hence the function. A minimum turn around time associated with operating on the information represented by the ranging signal can be utilized for a turn around time for the mobile device 104. Thus, the ranging module 108 can verify a distance calculated from a round trip propagation time plus the minimum turn around time if the response signal is properly processed using the function.

In still other aspects, ranging module 108 can determine a likelihood (e.g., a probability) that the mobile device 104 properly operated on a ranging signal sent by wireless transceiver 106. For example, ranging module 108 can employ statistical analysis to process the response signal received from the responding device to obtain a confidence level regarding whether the response to the ranging signal is proper. If the analysis is above a threshold confidence level, ranging module 108 can accept the response and verify a distance between devices (104, 106) calculated from such response. If the analysis is below the threshold confidence level, ranging module 108 can disregard the response signal. Accordingly, ranging module 108 can verify a distance (e.g., at least a minimum distance between devices 104, 106) based on a minimum time required to perform particular actions.

If a distance between mobile handset 104 and wireless transceiver 106 is verified by ranging module 108, DMC issuance module 110 can generate a DMC. The DMC can be in accordance with one or more rules provided by a sponsor. For instance, a sponsor can limit a number of DMCs to be generated for a particular product. As another example, a sponsor can limit a redeemable value associated with the DMC. As a further example, a sponsor can specify a minimum distance between a consumer's mobile device (104) and an issuing device (102) (e.g., located within a retail store, or the like) necessary to generate the DMC. As additional examples, a sponsor can limit generation of a DMC to mobile devices (104) participating in redemption of a prior DMC, participating in prior purchase of a sponsor product, prior purchase of a competing product, prior purchase at a competing store, and so on. It should be appreciated that a DMC can be generated based on a combination of the foregoing limitations or of the limitations.

If mobile device 104 qualifies for a DMC, DMC issuance module 110 generates such DMC and forwards it to the DMC device 102. DMC device 102 can then associate the DMC with the mobile handset 104. For example, the DMC can be stored in a database (not depicted) and associated with a particular state (e.g., active, redeemed, cancelled, etc.) and with an identifier of the mobile device 104 (e.g., a media access control [MAC] address or subscriber identify module of such device, or other suitable unique identifier). Value specified by the DMC can be redeemed by a user of the mobile handset 104 in conjunction with purchase, lease etc., of a product/service identified by the DMC, so long as the state of the DMC is active. If the state changes and is no longer active, for instance if the DMC is redeemed or if a sponsor cancels the DMC, the DMC can no longer be redeemed. According to some aspects, a message is sent to the mobile handset 104 indicating that a DMC has been generated and issued to the mobile handset 104. The message can be sent via e-mail, text messaging, instant messaging, short message service, peer-to-peer data transfer (e.g., over a wireless link connecting the wireless transceiver 106 with the mobile handset 104) and/or the like.

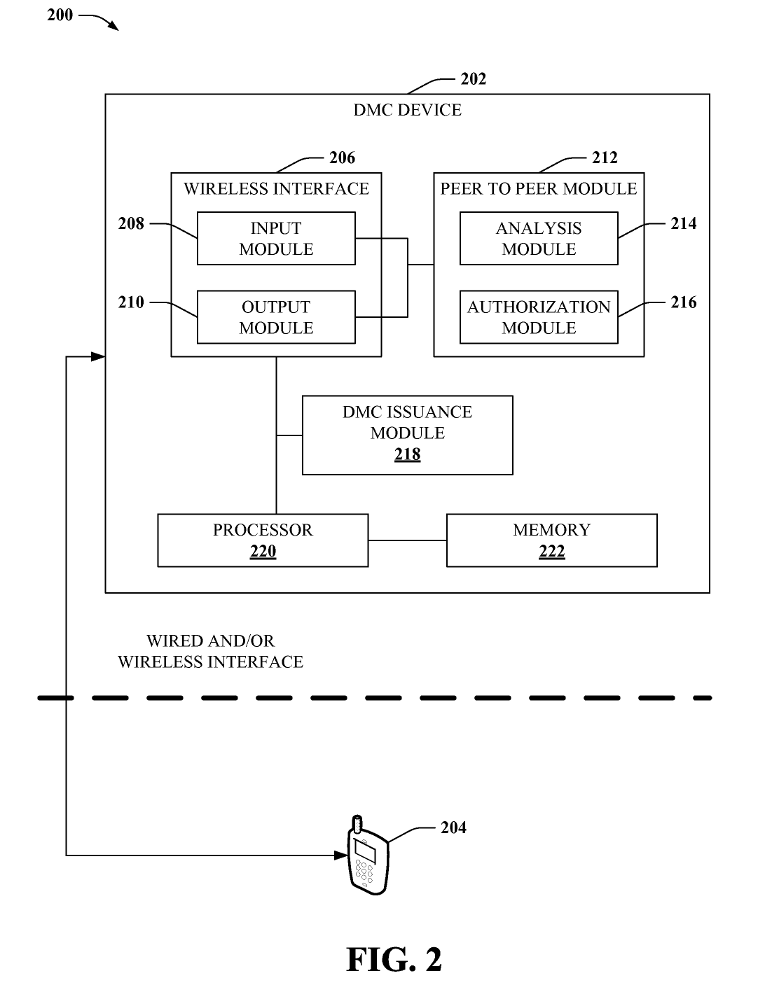

FIG. 2 depicts a block diagram of an example system 200 that can distribute a DMC based at least in part on a determined and/or verified distance (e.g., determined through P-P ranging, GPS determination, base station determination, etc.) to a mobile device 204. System 200 can include a DMC device that can generate and issue one or more DMCs based on predetermined criteria, including verified distance to a mobile device 204. The DMC device 202 is communicatively coupled with the mobile device 204 by a wired and/or wireless interface. Thus, a DMC(s) associated with the mobile device 204 can be based in part on proximity to a retail location, for instance, and/or proximity to a location of a competitor, or the like. Further, the distance can be verified by P-P ranging techniques, as discussed herein (e.g., see FIG. 1, supra).

DMC device 202 can further include a wireless interface 206 that can form a wireless link with one or more mobile devices (204). The wireless interface 206 can include an input module 208 for receiving data and an output module 210 for transmitting data. The wireless interface can further include components (not depicted) for modulating and/or demodulating transmitted signals, as suitable. In addition, DMC device 202 can include a processor 220 configured to access and/or execute various modules or interfaces of DMC device (206, 208, 210, 212, 214, 216, 218) and memory 222 configured at least to store data pertinent to such modules or interfaces (206, 208, 210, 212, 214, 216, 218).

In addition to the foregoing, DMC device 202 can include a peer to peer module (P-P module) 212. The P-P module 212 can be utilized to determine a distance between the DMC device 202 (e.g., a host device for managing DMCs) and one or more mobile devices 204 linked at least in part by a wireless interface. In addition, P-P module 212 can include an authorization module 216 that can verify the determined distance and mitigate device and/or distance spoofing. For instance, authorization module 216 can compare a response from mobile handset 204 to a minimum time associated with generating and/or transmitting such response. If the response is proper (e.g., see below), the mobile handset 204 can be verified as being a distance that is equal to or greater than the minimum distance. A DMC issued by DMC device 202 can be based at least in part on this verified minimum distance.

The P-P module 212 can further include an analysis module 214. Analysis module 214 can employ a function, sequence or the like to transform data involved in a wireless link between the DMC device 202 and the mobile handset 204. For instance, P-P module 212 and wireless interface 206 can send a ranging packet to the mobile handset 204 that includes data to be transformed by the sequence or function. A response packet sent by the mobile handset 204 can be transformed at the analysis module 214 to determine whether the function or sequence was properly followed. In addition, a minimum time to perform the transformation can be associated with a proper response packet. If the analysis module 214 determines that the response packet properly conformed to the function/sequence, the analysis module can further associate a minimum response time with the turnaround time required to generate and transmit the response packet. The minimum response time can be forwarded to authorization module 220 for verification of a minimum distance between the DMC device 202 and mobile handset 204.

In addition to the foregoing, DMC device 202 can include a DMC issuance module 218 that associated a DMC with the mobile device 204 based on comparison of a verified distance and at least one threshold distance. For instance, a minimum distance verified by authorization module 216 can be associated with the mobile handset 204. This minimum distance can then be compared with predetermined rules establishing generation of a DMC and value or limitations associated with the DMC. As a particular example, sponsor rules can specify that devices (104) between 0 and 50 meters of a DMC device (202) are to be provided a first DMC (e.g., a $5 discount off of a specified pair of shoes). Such rules can also specify that devices (104) between 50 and 100 meters of the DMC device (202) are to be provided a second DMC (e.g., a $7 discount off of the pair of shoes). These distance-based thresholds can be established based on buyer purchasing tendencies, for instance. For instance, it can be assumed that a greater purchasing incentive is desirable for potential consumers who are further from a store than those who are closer to the store. Alternatively, or in addition, it can be assumed that a greater purchasing incentive is desirable for potential consumers who are closer to a competitor's location. Thus, in some aspects, the increased value for the 50 to 100 meter threshold could be justified based on a known competitor that is 75 meters from the DMC device 202.

Once a DMC is generated by DMC issuance module 218, the DMC is stored in memory 222 and associated with an identifier of the mobile handset 204. Alternatively, or in addition, an electronic application containing a unique code associated with the DMC can be transmitted (e.g., by output module 210 and wireless interface 206) to the mobile handset 204. This electronic application can specify, for instance, a value of the DMC, applicable products/services the value can be applied to, and any limitations (e.g., time, location, etc.), pertinent to redeeming the DMC.

If mobile handset 204 is involved in a transaction identified by a DMC, the DMC can be redeemed to accord value specified by the DMC to such transaction (e.g., discount off of a sale price). In some aspects, the mobile handset 204 provides information identifying the handset (e.g., a MAC address, SIM module number, etc.), optionally at the request of the DMC device 202. DMC issuance module 218 can compare this information to issued DMCs stored in memory 222. If a stored DMC matches the information, DMC issuance module can further determine whether applicable rules necessary for redemption and/or pertinent to determining redemption value are complied with. If so, a value specified by the DMC can be applied to a purchase. The DMC issuance module 218 can then update a state of the DMC, indicating such DMC has been redeemed for instance (e.g., completely redeemed or redeemed in part, as suitable to applicable rules associated with the DMC).

According to other aspects, mobile handset 204 can provide information contained within an electronic application identifying a DMC to redeem the DMC. For instance, a DMC number can be associated with a particular DMC. An electronic application provided to mobile handset 204 can include this DMC number to identify the DMC and applicable terms, limitations, etc., of the DMC. Upon participating in a transaction specified by the DMC, mobile handset 204 can provide the DMC number to DMC device 202 to redeem value provided by the DMC. DMC issuance module 218 can receive the DMC number to reference applicable terms and limitations. If such terms/limitations are met by the purchase, the DMC can be redeemed and any value specified by the DMC provided in conjunction with the transactions. DMC issuance module can then update a status of the DMC and/or DMC number stored in memory 222.

As described, DMC device 202 can generate and issue a DMC based on applicable sponsor rules, based at least in part on a verified distance between such DMC device 202 and a mobile handset 204. DMC device 202 can further redeem the DMC in conjunction with an appropriate transaction and according to applicable DMC terms. Further, a status of the DMC can be updated to mitigate improper duplicate uses (e.g., multiple redemption of a single DMC). Thus, system 200 can limit exposure to spoofing and unauthorized redemption of a DMC by a spoofing device.

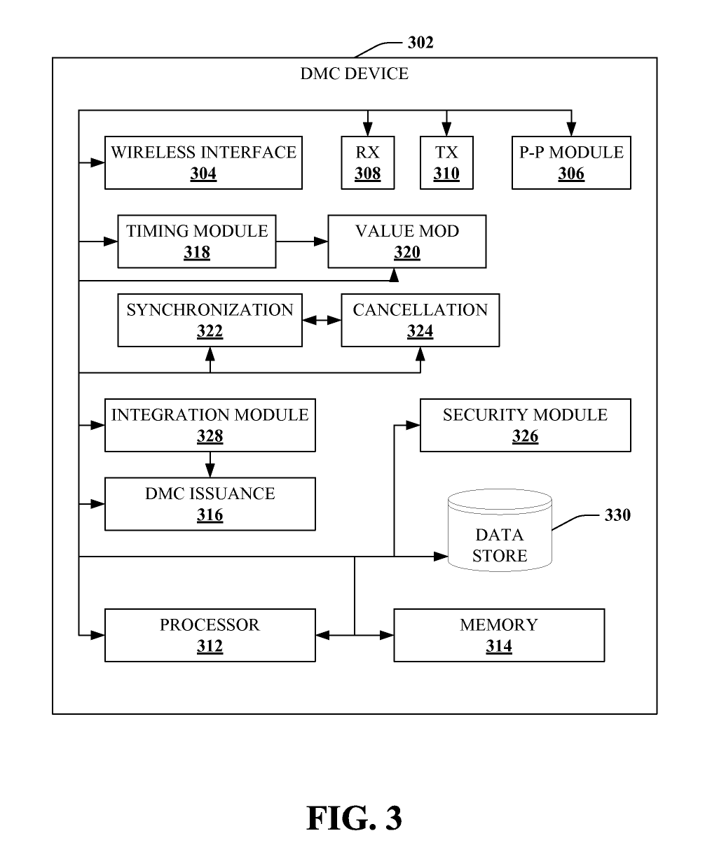

FIG. 3 illustrates a block diagram of a sample DMC issue and redemption device (302) according to one or more aspects. DMC device 302 can generate and issue a DMC to a mobile device (not depicted) based at least in part on verified distance between the DMC device 302 and the mobile device. The distance can be determined utilizing a wireless link established by a wireless interface 304 and a P-P ranging technique (e.g., signal ranging, round-trip ranging) implemented by a P-P module 306. Further, P-P module 306 can verify such distance to mitigate device spoofing. For instance, a mobile device can be required to perform analysis techniques requiring a minimum amount of time to complete. This minimum time can correspond to a minimum turnaround time, which P-P module 306 can utilize to calculate a minimum distance between the devices. This minimum distance can then be used by DMC device 302, at least in part, to determine whether a DMC should be issued to the mobile device, a value of the DMC, as well as other suitable terms and/or conditions. Specifically, a security module 326 can authenticate the mobile device with DMC device 302 based in part on the verified distance. A DMC can then be issued based on a concurrent, previous, and/or subsequent authentication.

Wireless interface 304 and/or P-P module 306 can include a transmitter 310 that sends, codes and/or modulates signals and data to other devices via a wired and/or wireless link. Additionally, a receiver 308 can be included that receives, decodes and/or demodulates signals and data from other devices via a wired and/or wireless link. Such signals and information can be pertinent to determining and/or verifying a distance between DMC device 302 and such other devices (e.g., signal propagation speed, send/receive time, turnaround time, round trip propagation time, functions and/or sequences pertinent to establishing a minimum turnaround time, and so on) as described herein.

In addition to the foregoing, DMC device 302 can include a processor 312 and memory 314. Processor 312 can implement logic functions of various modules (304, 306, 316, 318, 320, 322, 324, 326) discussed herein, analyze signals, and perform various electronic processing functions pertinent to electronic communication. Memory 314 can comprise RAM and other suitable memory for storing information pertinent to electronic communication and performing the logic functions of the various modules (304, 306, 316, 318, 320, 322, 324, 326).

According to some aspects, DMC device 302 can include a timing module 318. Timing module 318 can record and reference various start/stop times and elapsed times pertinent to issuance or redemption of a DMC, establishing a value of a DMC, determining or verifying a distance between wireless devices, or the like. For instance, timing module 318 can record a transmission time of a ranging packet and/or a response time associated with receiving a response packet. Further, timing module 318 can track an elapsed time after issuance of a DMC. In at least one aspect, timing module 318 can determine and record a time that the DMC is associated with/issued to a mobile device. According to some aspects, timing module 318 can reference an issuance time of a DMC and compare a concurrent time to the issuance time (e.g., where redemption is limited from a time of issuance). According to still other aspects, timing module 318 can record a redemption time of a DMC. The redemption time and other information associated with redemption of a DMC can be forwarded to a sponsor of the DMC for reimbursement of redeemed value or a portion thereof. Other suitable start/stop/elapsed times can be managed by timing module 318; such aspects known in the art or made known to one of skill in the art by way of the examples provided herein, are incorporated into the subject disclosure.

DMC device 302 can further include a value moderator 320 that can establish a relationship between a value of a DMC and one or more verified distances between DMC device 302 and a mobile device. In one aspect, value moderator 320 can generate or modify a redeemable value of the DMC based on a distance threshold determination. As an example, value moderator 320 can establish a hierarchy of two or more distance thresholds (e.g., as specified by a sponsor). The hierarchy can be applied to various aspects of the DMC, including redemption value, products/services applicable to the DMC, cancellation of the DMC, or the like. In particular aspects, value moderator 320 can adjust a dynamic commercial value of a DMC based on a comparison of the verified distance(s) and one or more distance thresholds specified in the hierarchy. For instance, a first threshold can correspond to a first value (e.g., a $1 discount), a second threshold can correspond to a second value (e.g., a $2 discount), and so on. In another example, if the verified distance(s) is below a threshold distance a first value can be generated (e.g., the $1 discount) and if the verified distance(s) is above the threshold distance a second value can be generated (e.g., the $2 discount). In such aspects, if a mobile device travels from a first threshold distance to a second threshold distance, a dynamic value of a distributed DMC can be updated accordingly.

According to one or more additional aspects, value moderator 320 can adjust a default commercial value of a DMC based on factors other than or in addition to verified distance. For instance, the commercial value can be adjusted based on a number or ratio of previously redeemed DMCs issued to and/or redeemed by a mobile device. As another example, the commercial value can be adjusted based on an elapsed time after issuance of the mobile device (e.g., determined by timing module 318), a time of day, or the like. According to one or more further aspects, the commercial value can be adjusted based on a second distance of the mobile device in comparison to a first verified distance. The second distance can be determined by P-P module 306, as described herein, or determined by GPS or base station location techniques. For instance, if the second distance is greater than the verified distance, the commercial value can be dynamically increased in order to provide further incentive to a potentially indecisive consumer. According to at least one aspect, the commercial value can be adjusted based on a comparison of the verified distance or the second distance with a known distance to a competing entity (e.g., measured from the DMC device and/or the mobile device). For example, if the mobile device is determined to be within a particular range (e.g., 30 meters) of a competitor, the commercial value can be adjusted to provide additional incentive to redeem the DMC at an entity associated with the DMC device 302 as opposed to the competitor. It should also be appreciated that value moderator 320 can adjust the commercial value of a DMC based on a combination of these or like determinable criteria.

According to one or more aspects, DMC device 302 can include a synchronization module 322 and a cancellation component 324. The synchronization module 322 can associate the DMC with a transaction and/or report redemption of a DMC to an issuing entity/sponsor associated with the DMC. Reporting can be in conjunction with obtaining indemnification from the issuing entity for at least a portion of commercial value provided when the DMC is redeemed. As a particular example, DMC device 302 can be associated with a retail store. The retail store can carry and sell shoes or other wares of a shoe manufacturing company. In addition, the shoe manufacturing company could authorize the retail store to issue coupons, including DMCs, which provide point-of-sale value for purchase of a pair of shoes. Upon submitting proof of a sale of the pair of shoes, and proof that the point-of-sale value was provided in conjunction with such sale, the shoe manufacturing company reimburses the retail store the point-of-sale value. To obtain reimbursement, synchronization module 322 can submit information pertaining to the sale of the pair of shoes (e.g., a time of sale, a time of redemption, electronic payment for the pair of shoes and/or credit/debit card payment information, cash tendered, DMC value provided etc.). Synchronization module 322 can then receive the reimbursement from the shoe manufacturing company, or submit payment for the pair of shoes less the value (or portion thereof) identified by the DMC, or the like.

Cancellation module 324 can update a status of a redeemed DMC at a data store 330. For instance, data store 330 can record and maintain a database of issued DMCs, associated mobile devices/mobile device users, and DMC status, including whether a DMC is available to be redeemed (e.g., active), whether the DMC has already been redeemed, or whether the DMC is cancelled, and/or the like. If an active DMC is redeemed, cancellation module 324 can update the status of such DMC to prevent unauthorized subsequent redemption of the same DMC. If an active DMC is cancelled (e.g., by a sponsoring entity) the cancellation component 324 can update the status to indicate cancellation and consequently prevent further redemption. Cancellation component 324 can further send a change of status notice to a mobile device issued/associated with the DMC as suitable (e.g., via e-mail, text message, short message service, voice call, video call, P-P messaging/calling, or the like). Accordingly, cancellation module 324 can help to prevent unauthorized redemption of a DMC, and can further notify consumers of a change in status of DMCs.

According to some aspects, it can be desirable to include media information to a mobile device in addition to information pertaining to a DMC (e.g., applicable products, concurrent value, limitations, dynamic factors, and so on). Accordingly, DMC device 302 can include an integration module 328 that can include additional media with distribution of a DMC. The additional media can be directed at promoting product(s) identified in the DMC, clarifying and/or qualifying details of the DMC (e.g., terms, limitations, dynamic factors, etc.), or the like.

As a particular example, it can be desirable to distribute an advertisement of a device or other product of a sponsoring entity in conjunction with a DMC. The advertisement could describe a product associated with the DMC, including product quality, value, benefits, and/or other desirable sales or marketing information. The advertisement can include various media, including text, video, audio, pictures, and/or combinations thereof. In one example, the advertisement could include an audio-visual presentation file that can be displayed on a screen of the mobile device. In other examples, the advertisement could include information pertinent to other products of a sponsor of the DMC (e.g., other than or in addition to a product(s) identified in the DMC), partners of the sponsor, of a retail store associated with DMC device 302, or of a third-party DMC distributor, or a combination thereof. In one aspect the advertisement can specify a sponsoring entity, a commercial value provided by the DMC, associated products/services, time and/or date of issuance, identification information of the mobile device (e.g., required to redeem the DMC), or a combination thereof or of the like.

If a user of the mobile device wishes to redeem the DMC, or obtain more details regarding the DMC, the user can select or access a message pertinent to the DMC on a user interface of the mobile device. In such case, advertisement media can be activated and played. Thus, in some aspects, additional media can be played only if the user expresses some interest in the DMC. Media as described herein can be obtained from a sponsor of the DMC, the retail store, generated by DMC device 302, and so on. Integration module 328 can provide the media to the DMC issuance module 316 for incorporation into the DMC. The combined DMC and media can then be transmitted to a mobile device, based in part on verified distance between the mobile device and DMC device 302, as described herein.

It should be appreciated that a DMC as described herein can be limited by sponsor rules and instructions. Such rules and instructions can be stored within a sponsor database maintained by data store 330. The rules/instructions can include, for instance, instructions pertaining to a number of DMCs to distribute, a time period for distributing the number of DMCs, or deadline for redeeming the DMC/canceling the DMC, or a combination thereof or of like rules. Such rules can be included within information pertaining to the DMC sent to a recipient mobile device. In addition, such rules can also be submitted to a sponsoring entity for review and verification. In some aspects, the sponsoring entity can update the rules/instructions as desired. Changes to rules/instructions can optionally be forwarded to affected mobile devices as suitable. Accordingly, DMC device 302 can maintain a concurrent database (330) of rules for issuing, redeeming, canceling, etc., DMCs according to sponsors of such DMCs.

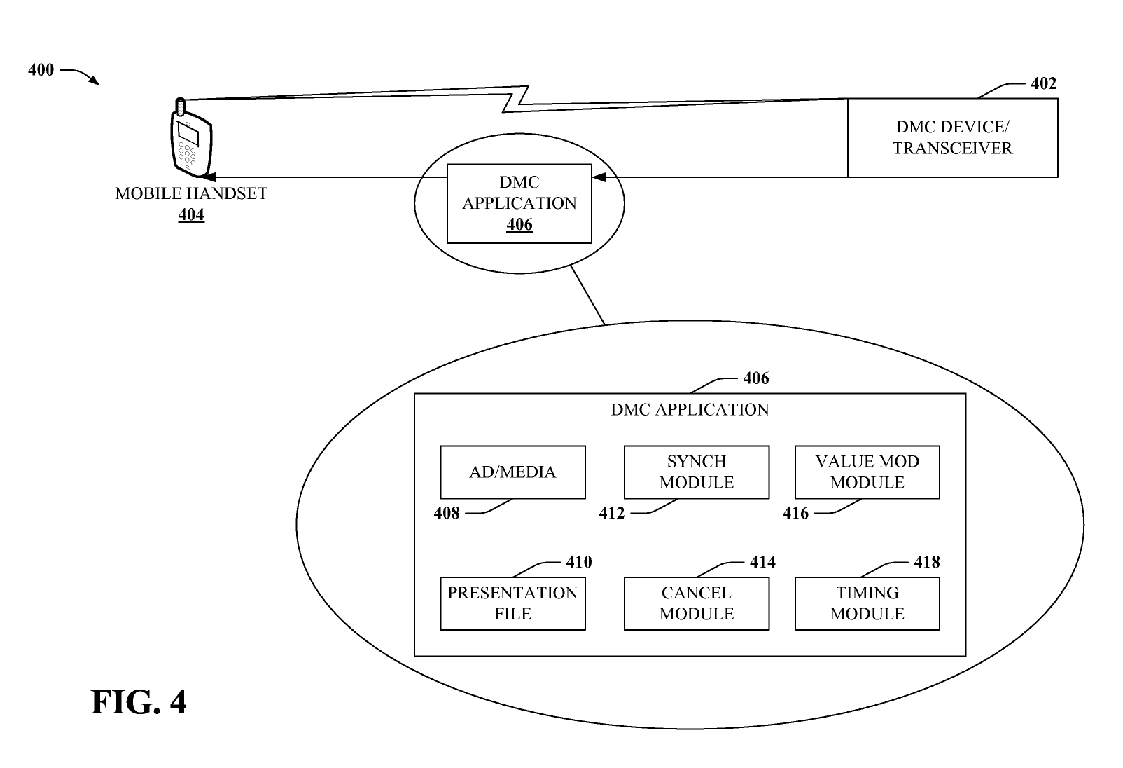

FIG. 4 depicts a block diagram of an example system 400 in accordance with some aspects of the subject disclosure. Specifically, system 400 depicts an example DMC application 406 that can be provided to a mobile handset 404 from a DMC device/transceiver 402 based in part on a verified distance between such devices (402, 404). The DMC application 406 can contain various modules, data files, and/or components (408, 410, 412, 414, 416, 418) pertinent to defining, describing and/or qualifying a DMC. For instance, the DMC application 406 can describe a commercial value provided by the DMC, what transactions and products/services the commercial value is applicable to, what limitations and qualifying conditions are applicable to the transactions, instructions for redeeming the DMC, where the DMC can be redeemed, and so on. In addition, the DMC application can provide and update a status of the DMC. According to still other aspects, the DMC application 406 can determine, update, and/or set a dynamic commercial value provided by the DMC. According to still other aspects, the DMC application 406 can play advertisements and related media pertinent to the transaction, product(s), sponsor, issuing entity, or related retail store, or a combination thereof or of the like.

Upon issuing a DMC, DMC device/transceiver 402 can send the DMC application 406 to a mobile handset 404. DMC application 406 can include various modules 408, 410, 412, 414, 416, 418 that can determine dynamic parameters associated with the DMC. Thus, the DMC application 406 can provide most information pertinent to redeeming the DMC at the mobile handset 404. In some aspects, the DMC application 406 can, at a minimum, identify a commercial value provided by the DMC, a product or service associated with the value, and terms/conditions for redeeming the DMC. By incorporating redemption information into an application (406) provided to the mobile handset 404, subsequent communication between the mobile handset 404 and DMC device/transceiver 402 can be minimized prior to redeeming the DMC.

DMC application 406 can include various advertisements and/or media 408 pertaining to products/services associated with the DMC. For instance, if the DMC provides commercial value that can be redeemed in conjunction with sale of an audio CD, the advertisement/media could include a preview of tracks on the CD, information about a performing artist, etc. It should be appreciated that ad/media 408 can further be related to a sponsoring entity (e.g., record label), a DMC distribution entity, a retail store containing the DMC device/transceiver 402 (e.g., a music store), related products (e.g., other performances by the same or similar artists), and so on. The ad/media 408 can be included within a presentation file 410 that can be played on the mobile handset 404.

According to some aspects, DMC application 406 can include a synchronization module 412 that can participate in redeeming the DMC. The synchronization module 412 can provide information identifying the mobile handset 404, or the DMC application 406, to a redemption entity (402). Accordingly, the redemption entity (402) can be apprised of any DMCs associated with the mobile handset 404.

According to further aspects, the synchronization module 412 can receive information pertinent to a transaction from the redemption entity (402) and determine whether rules and/or limitations pertaining to redemption of the DMC are applicable to a transaction. For example, synchronization module 412 can determine any limitations pertinent to redemption (e.g., time) of a DMC and whether the limitations are met by a transaction. In addition, the synchronization module 412 can identify products applicable to a DMC. In some aspects, synchronization module 412 can provide information to be output by the mobile handset 404 notifying a user that a DMC can be redeemed by a proposed transaction (e.g., a transaction initiated electronically between the mobile handset 404 and DMC device/transceiver 402). As a particular example, if a mobile handset 404 is involved in purchasing a product (e.g., by providing electronic payment), synchronization module 412 can request an identity of the product and compare such product(s) with those specified in a DMC (406). If the purchased product matches a product identified in the DMC (406), and other terms or limitations are also met for the transaction (e.g., time, location, related offers), synchronization module 412 can dynamically output a notification at the mobile handset 404 or DMC device/transceiver 402 (e.g., by way of a wireless link with such device). Accordingly, synchronization component 412 can notify a device user if a DMC can be redeemed in conjunction with a particular transaction.

DMC application 406 can further include a cancellation module 414 that can store and update a status of a DMC. For instance, the cancellation module 414 can identify whether the DMC is active, redeemed, cancelled, etc. In addition, cancellation module 414 can respond to a query regarding status of the DMC (e.g., from a user of the mobile handset 404, the DMC device/transceiver 402, etc.). Thus, the DMC application 406 can determine and provide the status of the DMC at the mobile handset 404, further limiting required communication between the mobile handset 404 and DMC device/transceiver 402 after issuance of the DMC.

In addition to the foregoing, DMC application 406 can include a value module 416 that can determine and/or update a concurrent value associated with a DMC. In some aspects, a commercial value associated with the DMC can be dynamic and dependent on determinable conditions associated with the mobile handset 404 or DMC application 406. For instance, value can be determined based on elapsed time since the DMC is issued determined by a timing module 418. As another example, value can be determined based on a verified distance hierarchy determined by P-P ranging as described herein. As a further example, value can be based on proximity of the mobile handset 404 to a known competitor of the DMC device/transceiver 402 or sponsoring entity, as suitable. Dynamic value can be updated at a display of the mobile handset 404 to inform a user of any change in value.

In some aspects, value module 416 can receive user input to lock a certain displayed value. For instance, value module 412 can display a concurrent value of the DMC at the mobile handset 404 based on determinable criteria. Further, the value module 412 can display a query to determine whether the value is to be ‘locked in’, preventing further changes in value, subject to certain conditions (e.g., a maximum time of redemption determined by timing module 418). If the value module 412 receives input associated with locking the value, no further value updates will be conducted (except, e.g., as indicated by the certain conditions).

According to some aspects, a DMC authorization entity such as DMC device 402 (or, e.g., a redemption entity, a DMC sponsor, a coupon clearinghouse that reimburses retail or redemption entity in conjunction with redeeming the coupon, etc.) can unlock and/or override a value locked by value module 420. For example, overriding or unlocking a value established by a mobile device user can be in accord with predetermined redemption or valuation rules provided by a sponsor of the DMC. An unlocking/override function can enable the DMC device 402 or authorization entity to update a value of the DMC as applied to a transaction. Thus, a coupon sponsor could retain a right and ability to review a coupon value upon redemption of the coupon, and update the value accordingly.

As described above, DMC application 406 can manage dynamic parameters associated with one or more DMCs issued to the mobile handset 404. Dynamic parameters can be useful to increase or decrease purchasing incentive based on dynamic circumstances associated with the mobile handset 404. To reduce dependence on continuing wireless communication between the handset 404 and an issuing device 402 in applying the dynamic circumstances, DMC application 406 can determine and apply such parameters to aspects of a DMC, as described above.

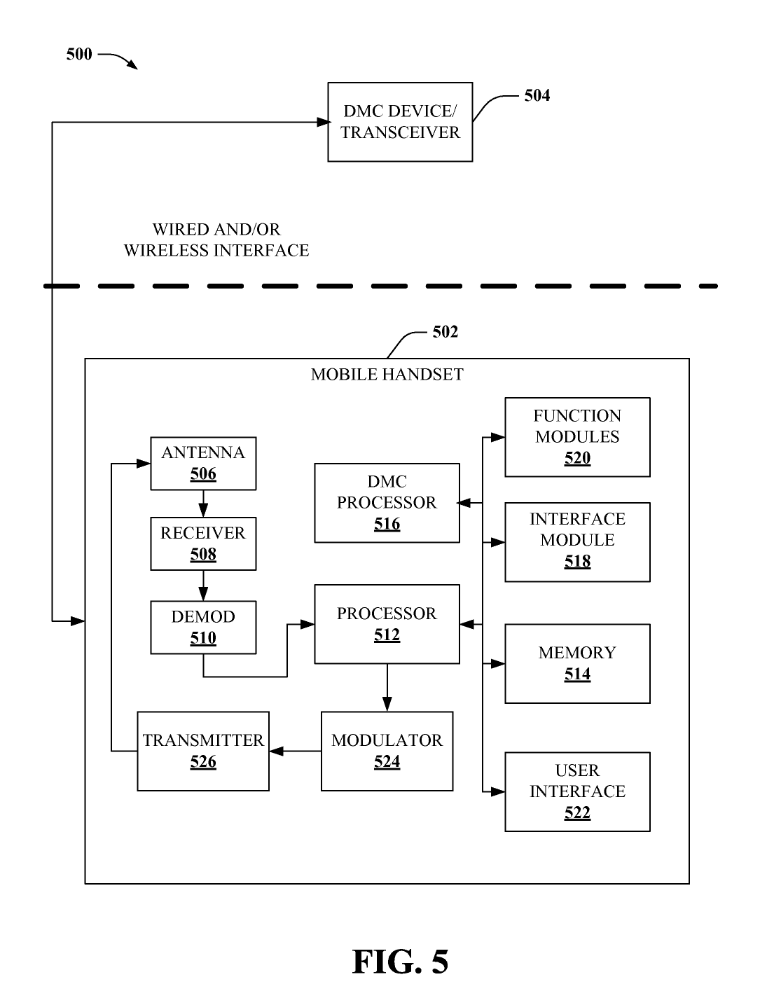

FIG. 5 illustrates a block diagram of an example system 500 that facilitates receipt, use, and redemption of a DMC according to some aspects. System 500 can include a mobile handset 502 that can form a wireless link with a DMC device/transceiver (DMC device) 504. The DMC device/transceiver can issue one or more DMCs to the mobile handset based at least in part on a verified distance between the devices (502, 504). In addition, the verified distance can be based on P-P ranging as described herein. Mobile handset 502 can provide information pertinent to determining and/or verifying the distance, such as responding to a ranging packet, applying a sequence or function to ranging data and/or providing identifying information associated with the mobile handset 502 to the DMC device 504.

Mobile handset 502 includes at least one antenna 506 (e.g., a transmission receiver or group of such receivers comprising an input interface) that receives a signal (e.g., pertaining to voice call, data transfer, P-P ranging request, and so on) and a receiver 508, which performs actions (e.g., filters, amplifies, down-converts, etc.) on the received signal. Specifically, antenna 506 can receive a request to respond to a ranging packet send by DMC device 504. The request can also specify a sequence or function to be applied to ranging information and sent in a response packet, in conjunction with verifying a minimum distance between devices (502, 504) as described herein. For instance, a DMC processor 516 can generate information in response to the ranging packet. The information can be based on instructions specified by the ranging packet (e.g., pertaining to applying a sequence or function to data), instructions stored at memory 514, or dynamically established at least in part by the DMC device 504 and DMC processor, or a combination thereof.

Antenna 506 and receiver 508 can also be coupled with a demodulator 510 that can demodulate received symbols and provide them to a processor 512 for evaluation. Processor 512 can analyze information received by antenna 506 or a user input interface of the mobile device (522), and/or generate information for transmission by a transmitter 526. Additionally, processor 512 can control and/or reference one or more components (506, 508, 510, 514, 516, 518, 520, 522) of the mobile handset 502. Additionally, processor 512 can execute one or more modules, applications, or the like (520) that comprise information or controls pertinent to determining and/or verifying a distance between devices (502, 504) utilizing P-P ranging. Alternatively, or in addition, such modules (520) can comprise information or controls pertaining to receiving and/or redeeming a DMC, as described herein.

Mobile handset 502 can additionally include memory 514 that is operatively coupled to processor 512. Memory 514 can also be coupled with an interface module 518 that can obtain access to a DMC associated with mobile handset 502 based at least in part on a verified distance between the receiving mobile device and a DMC host device. The distance can be determined, for instance, at least in part from a first signal sent from DMC device 504 to mobile handset 502 and/or a second signal sent from mobile handset 502 to the DMC device 504 in response to the first signal. Moreover, the distance can be verified, at least as a minimum distance, by performing actions that require a minimum turnaround time, as described herein.

Memory 514 can further store data to be transmitted, received, and the like. Such data can be pertinent to determining/verifying a distance between mobile handset 502 and DMC device 504. Alternatively, or in addition, the data can be pertinent to playing a media file associated with a DMC at user interface 522 of mobile handset 502. Such media file can identify a product and redeemable value associated with the DMC, as well as applicable terms and/or limitations. The media file can further include advertisement data pertinent to the product, a sponsor of the DMC, related products, and so on.

Mobile handset 502 still further comprises a modulator 524, and a transmitter 526 that transmits generated signals (e.g., by processor 512 and modulator 524) to, for instance, a base station, an access point, another access terminal, a remote agent, etc. Although depicted as being separate from the processor 512, it is to be appreciated that primary application 514 and/or second application 516 can be part of processor 512 or a number of processors (not shown).

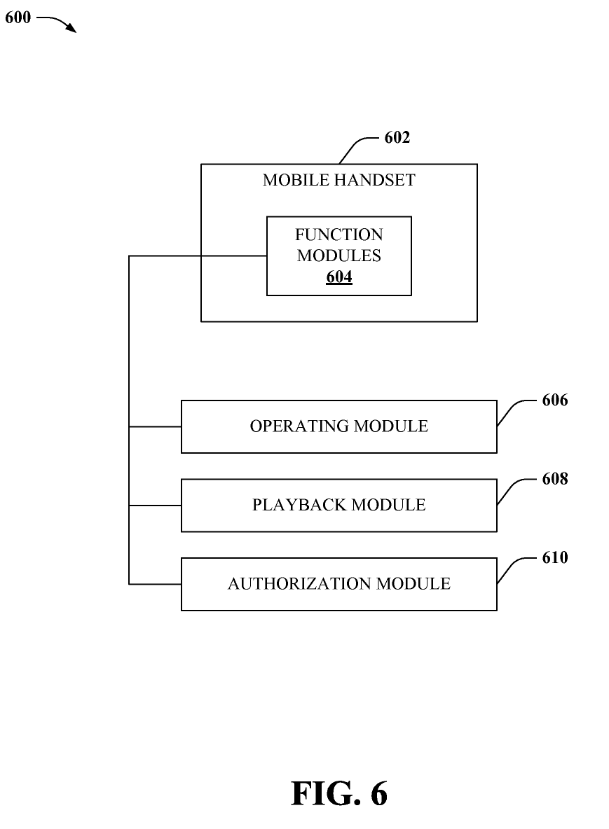

FIG. 6 depicts an example system 600 of a mobile handset 602 coupled with various function modules 604 pertinent to aspects of the subject disclosure. The function modules 604 can include, for instance, an operating module 606, playback module 608, and authorization module 610. It should be appreciated that other modules pertaining to determining or verifying a distance between devices utilizing P-P ranging can be included within function modules 604. In addition, other modules pertaining to identifying, utilizing, and/or redeeming a DMC can also be included within function modules 604.

Operating module 606 can participate in determining or verifying a distance between mobile handset 602 and another wireless device (not depicted). For instance, the operating module 606 can apply a sequence (e.g., predetermined, random, pseudo-random, etc.) specified by the wireless device to a set of data. The sequence and set of data can be associated with a minimum processing time, which can be utilized in part to determine a minimum distance between the mobile handset 602 and wireless device. As a particular example, mobile handset 602 can receive a first signal from the wireless device containing data and a random sequence to be applied to such data. Operating module 606 can apply the random sequence to the data and present the result to the mobile handset 602. Such result can be included into a second signal transmitted to the wireless device in response to the first signal. The second signal can be utilized to determine and/or verify a minimum distance between the devices as described herein.

Playback module 608 can play media pertinent to a DMC at a user interface (not depicted) of the mobile handset 602. The media can provide information about the DMC, such as a value redeemable in conjunction with a commercial transaction. Such value can be a static value, or dynamic value based on a set of determinable conditions, as described herein or known in the art. The media can further update the mobile handset 602 with a concurrent value based on a state of the determinable conditions. In addition, the media can identify, describe, and/or promote a product or service associated with the DMC, an entity sponsoring the DMC, or include information pertaining to redeeming the DMC, or a combination thereof.

Authorization module 610 can provide security information pertaining to the mobile handset 602 in response to receiving a signal from an external wireless device (e.g., a DMC issuing device). The security information can include identification information uniquely identifying the mobile handset 602. Such information can include, for instance, a SIM number of the mobile handset 602, MAC address of the mobile handset 602, or the like. The security information can also include data pertaining to a verified distance between the handset 602 and the external wireless device. Such data can comprise, for instance, a distance determined and verified over a wireless link between the mobile handset 602 and the external wireless device, one or more subsequent distances between the mobile handset and such wireless device, or a combination thereof. Subsequent distances can be determined via P-P ranging, as described herein, through GPS location techniques, or base station location techniques, as known in the art.

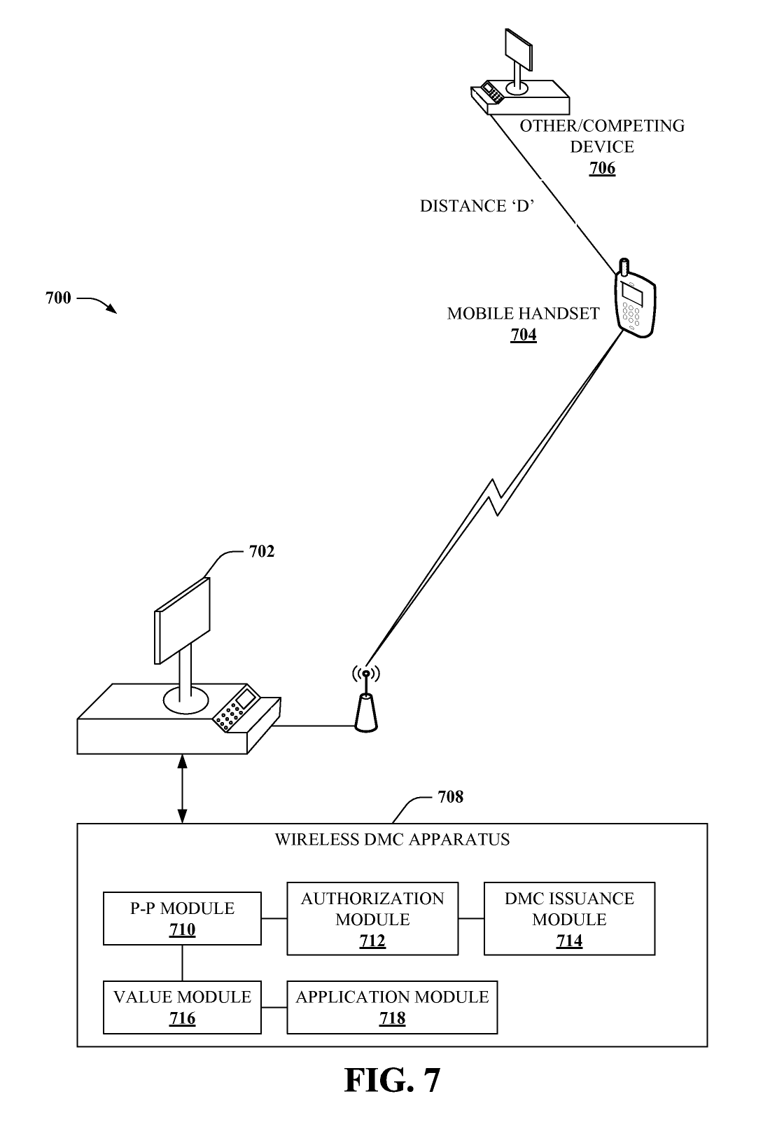

FIG. 7 illustrates a block diagram of an example system 700 that can generate and distribute one or more DMCs in a commercial environment. An issuing device 702 can generate a DMC based at least in part on determined and/or verified distance between the issuing device 702 and a mobile handset 704. The issuing device 702 can comprise, for instance, a sale register of a commercial store, an additional mobile device, or the like. Further, a value of the DMC can be based at least in part on a distance between the mobile handset 704 and a competing device 706.

Issuing device 702 can include a wireless DMC apparatus 708 that can determine a distance between the issuing device and other wireless devices (704, 706), verify such distance, issue a DMC based on the distance, provide a value of the DMC, or apply the DMC or the value to a transaction, or a combination thereof. The wireless DMC apparatus 708 can include a P-P module 710 that can generate, send, and receive signals to other wireless devices (704, 706). The P-P module can determine a distance between the issuing device 702 and such other wireless devices as described herein (e.g., utilizing signal ranging, round trip ranging, or the like).

The wireless DMC apparatus can also include an authorization module 712 that can verify a distance between the issuing device 702 and another wireless device (704, 706). The distance can be verified, for instance, by requiring mobile handset 704 to perform suitable actions requiring a minimum turnaround time. Once distance is verified, authorization module 714 can authenticate mobile handset 704, and DMC issuance module 714 can issue a DMC to mobile handset 704 based at least in part on such authentication.

Value module 716 can provide a static or dynamic value for a DMC generated by the DMC issuance module 714. Such value can be redeemed in conjunction with a commercial transaction at the issuing device 702, or another specified device (e.g., as provided by the DMC). For instance, application module 718 can apply the DMC and/or a value associated with the DMC (e.g., determined upon initiating or completing the transaction) to the transaction. As a result, a price can be discounted, a second item can be provided at reduced cost, a lease or rental fee can be reduced, transaction cost mitigated, and so on.

The static or dynamic value can be based in part on a determined distance between the issuing device 702 and mobile handset 704, a subsequently determined distance between such devices 702, 704 (e.g., determined by P-P module 710, a GPS system, or base station), an elapsed time after issuance of the DMC, or the like. In addition, value module 716 can determine the value at least in part based on a comparison of the determined/verified distance and a location of a competing device 706. Such competing device can be associated with, for instance, a retail store that competes with and/or provides similar products or services as an entity related to the issuing device 702. As a particular example, value module 716 can increase a redeemable value of the DMC to provide additional purchasing incentive. Such additional purchasing incentive can also be to discourage a potential consumer from transacting with the competing device/entity 706.

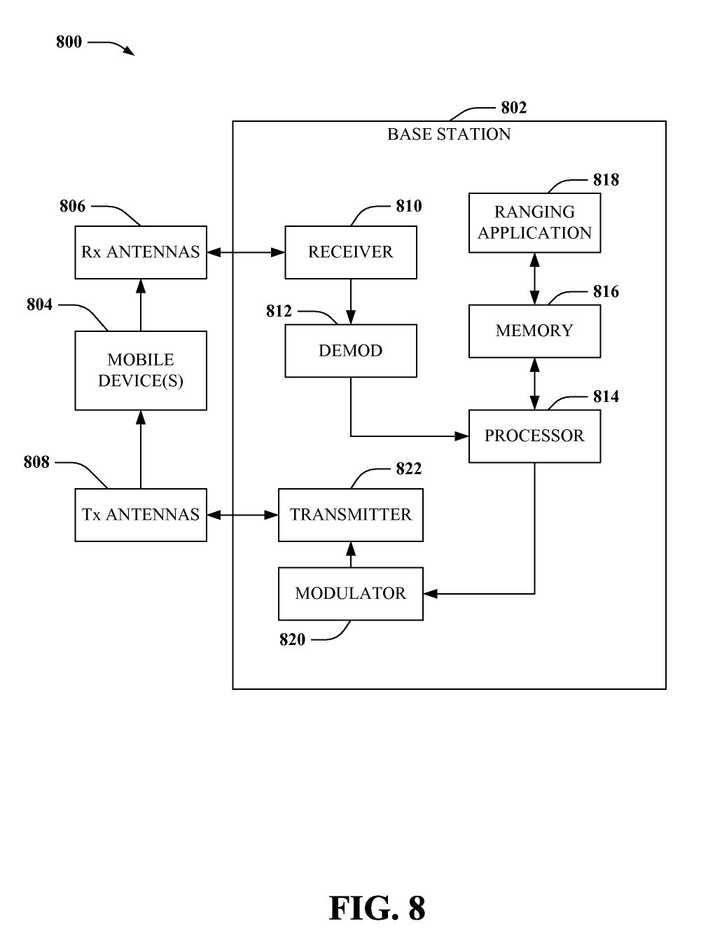

FIG. 8 illustrates an example system 800 that can provide additional location information pertaining to one or more mobile devices 804 according to one or more aspects. The additional location information can provide a further verification of a device to device (804) distance determined through P-P ranging, as described herein. Alternatively, or in addition, system 800 can provide a subsequent device to device (804) distance determination between a mobile device 804 and a wireless DMC issuing device (not depicted). The subsequent distance determination can be utilized to identify a travel direction of the mobile device 804 with respect to the DMC issuing device, and adjust a value of a DMC based at least in part on such travel direction (e.g., if the device is traveling away from the DMC issuing device, the value of the DMC can be increased to provide increased purchasing incentive).

System 800 comprises a base station 802 (e.g., access point, etc.) with a receiver 810 that receives signal(s) from one or more mobile devices 804 through a plurality of receive antennas 806, and a transmitter 822 that transmits to the one or more mobile devices 804 through a transmit antenna 808. Receiver 810 can receive information from receive antennas 806 and can further comprise a signal recipient (not shown) that receives requested log data from one or more mobile devices. Additionally, receiver 810 is operatively associated with a demodulator 812 that demodulates received information. A processor 814 can analyze demodulated symbols provided by demodulator 812 and can provide data to be transmitted first to a modulator 820 for symbol modulation and then to transmitter 822. The processor 814 further couples to a memory 816 that can store a ranging application 818 that can determine a location of one or more devices maintaining a wireless link with the base station 802.

For instance, ranging application 818 can be configured to perform diagnostic functions related to determining a position of a wireless device 804, verifying the position of the wireless device 804, determining a distance between the wireless device 804 and base station 802, or between multiple wireless devices 804, or combinations thereof. The diagnostic application 818 can send a signal to one or more mobile devices 804 requesting a response to the signal. The response can include a time that the signal is received at the mobile device(s) 804, a turnaround time associated with responding to the signal, or the like. Further, the ranging application 818 can determine a distance to the mobile device(s) 804 based on the signals, and a relative position of the mobile device(s) 804 based on such distance and a known location of the base station 802, as known in the art. The position of the mobile device(s) 804 can be utilized to verify a P-P distance determined between two such devices (804), or provide an updated distance subsequent to the P-P distance. The subsequent distance can be utilized to establish or update a redeemable value of a DMC issued to the mobile device(s) 804 based at least in part on the P-P distance. For example, a direction of travel of such mobile device(s) 804 (e.g., relative to a DMC issuing device) can be pertinent to determining the redeemable value.

The aforementioned systems have been described with respect to interaction between several components, modules, and/or electronic interface functions. It should be appreciated that such systems and components/modules/functions can include those components or sub-components specified therein, some of the specified components or sub-components, and/or additional components. For example, a system could include DMC device 102, mobile handset 104, P-P module 306, timing module 318, value module 320, and wireless interface 304, or a different combination of these and other components. Sub-components could also be implemented as components communicatively coupled to other components rather than included within parent components. Additionally, it should be noted that one or more components could be combined into a single component providing aggregate functionality. For instance, synchronization module 322 can include cancellation module 324, or vice versa, to facilitate determining and updating a status of a DMC by way of a single component. The components may also interact with one or more other components not specifically described herein but known by those of skill in the art.

Furthermore, various portions of the disclosed systems can include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems more adaptive as well as efficient and intelligent.

It is to be understood that the aspects described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the aspects are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

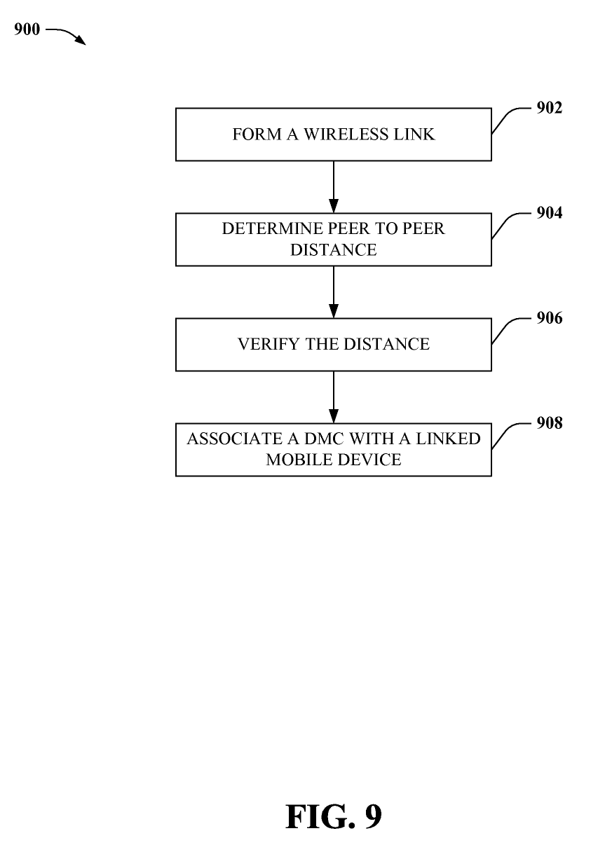

Referring to FIGS. 9-12, methodologies relating to providing DMCs in a P-P wireless environment based on a verified distance between at least two devices are provided. While, for purposes of simplicity of explanation, the methodologies are shown and described as a series of acts, it is to be understood and appreciated that the methodologies are not limited by the order of acts. For example, in accordance with one or more aspects, some acts can occur in different orders and/or concurrently with other acts from that shown and described herein. In addition, those skilled in the art will understand and appreciate that a methodology could alternatively be represented as a series of interrelated states or events, such as in a state diagram. Moreover, not all illustrated acts are necessarily required to implement a methodology in accordance with one or more aspects.

FIG. 9 illustrates an example methodology 900 for generating and distributing a DMC in a P-P wireless environment. At 902, method 900 can form a wireless link with a mobile device. The mobile device can be any suitable electronic communication device capable of participating in wireless data transfer. Such mobile device can include a cell phone, a mobile phone, a multi-mode phone, a PDA, a laptop, or a combination thereof or of like devices.

At 904, method 900 can determine a peer to peer distance (P-P distance) from a first wireless device to the mobile device. The distance can be determined based on signal ranging, round trip ranging, or a combination of these or like P-P techniques. At 906, method 900 can verify the distance determined at reference number 904. Verification can be based on actions performed by the mobile device that require a minimum amount of time. Actions can include responding to a signal within a certain period of time, transforming data by a predetermined sequence or function, or the like. The actions can be associated with a minimum turnaround or processing time, and such minimum time can be utilized to determine a minimum distance between the mobile device and first wireless device. At 908, method 900 can associated a DMC with the mobile device based at least in part on the minimum distance. Accordingly, a verified distance can be utilized as a condition to generating and associating a DMC with a mobile device, to reduce a likelihood that the mobile device is spoofed by an unauthorized device.

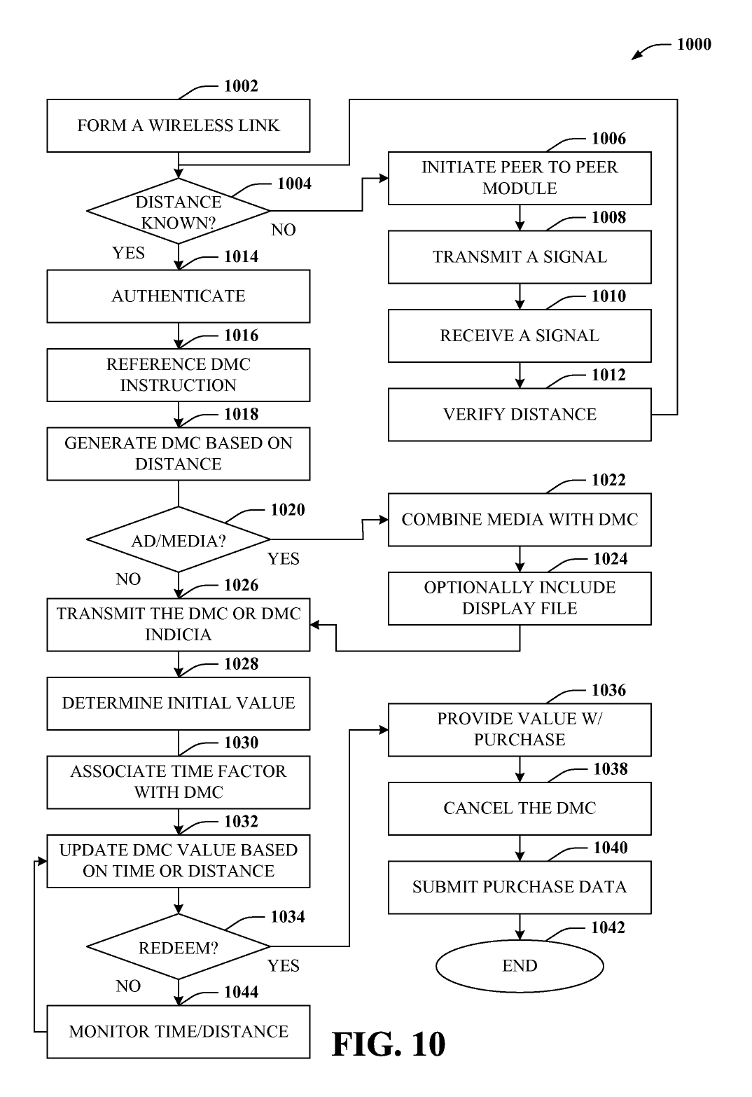

FIG. 10 provides an example methodology 1000 pertinent to providing a DMC in a wireless P-P environment according to one or more aspects. At 1002, a wireless link can be formed with a mobile device. At 1004, a determination can be made as to whether a distance between the mobile device and a DMC issuing device is known and verified. If the distance is not known and verified, method 1000 can proceed to 1006, if the distance is known and verified, method 1000 can proceed to 1014.

At 1006, a P-P module can be initiated. The P-P module can transmit a first signal from the DMC issuing device to the mobile device at 1008. At 1010, a reply signal can be received from the mobile device in response to the first signal. At 1012, a distance between the devices can be determined at least in part based on the first signal and the reply signal. If the distance corresponds with a minimum distance associated with performing predetermined actions (e.g., receiving the response within a certain time, performing data transformation based on a predetermined sequence and/or function within a certain time, or the like), the distance can be verified. Methodology 1000 can then return to reference number 1004.

At reference number 1014, methodology 1000 can authenticate a mobile device if distance to such device is known and verified, as described herein. At 1016, a DMC instruction can be referenced. The DMC instruction can specify whether a DMC can be generated based on the verified distance. The DMC instruction can also specify a commercial value associated with the DMC, a transaction to redeem the DMC, and/or a product or service associated with the transaction. At 1018, a DMC can be generated based on the verified distance and the DMC instruction.

At 1020, a determination can be made as to whether an advertisement or media is to be associated with the DMC (e.g., by the DMC instruction). The ad/media can be pertinent to the DMC, instructions for redeeming the DMC, a product associated with the DMC, a sponsor or retail store associated with issuing or distributing the DMC, or the like. If ad/media is to be associated with the DMC, method 1000 can proceed to 1022 where the ad/media is combined with the DMC. At 1024 method 1000 can optionally include the ad/media as a display file with the DMC. In such a manner the ad/media can be played on a user interface of the mobile device, for instance.

At 1026, the DMC or an indication of such DMC can be transmitted to the mobile device. Ad/media included with the DMC at reference number(s) 1022 and/or 1024 can further be transmitted with the DMC or indication thereof. An indication of the DMC can comprise a message (e.g., text message, short message, voice call, or the like) identifying the DMC and details pertinent to redeeming the DMC, or a manner in which such information can otherwise be obtained (e.g., by accessing an HTML link to an Internet site containing such information).

At 1028, an initial commercial value can be generated for the DMC. Such initial commercial value can be transmitted with the DMC at reference number 1026, or subsequent such transmission. The initial value can be in accordance with at least the DMC instruction. In addition, the initial value can be based in part on the verified distance determined above. In some aspects, the initial value can be based on a purchase history associated with the mobile device, such as DMC redemption history, purchase history pertinent to a particular product, a particular store, a particular manufacturer, and/or the like.

At 1030, a time factor can be associated with the DMC. The time factor can record at least a time of transmission of the DMC or indication thereof to the mobile device. The time factor can be utilized to compute a redemption time, or to alter the initial value associated with the DMC, identified at reference number 1028. At 1032, the DMC value can be updated based on an elapsed time or concurrent distance of the mobile device. For instance, the value can be increased or decreased based on one or more predetermined elapsed time thresholds following issuance of the DMC. Alternatively, or in addition, the value can be increased or decreased based on a subsequent distance determination, for instance, identifying a direction of travel of the mobile device with respect to the DMC issuing device. According to still other aspects, a combination of these or like factors, described herein or known in the art, can be utilized to update the value associated with the DMC.

At 1034, a determination can be made as to whether the DMC is presented for redemption. If the DMC is presented for redemption, method 1000 can proceed to reference number 1036. If the DMC is not presented for redemption, method 1000 can proceed to 1044 where time and/or distance (e.g., with respect to an issuance time or verified distance determination) of the mobile device can be further monitored. As time and/or distance changes, method 1000 can return to reference number 1032 to determine whether an updated value is to be provided to the DMC.

At reference number 1036, method 1000 can provide a value and/or concurrent value (e.g., in the case of an updated value) specified in the DMC in conjunction with a transaction, rules and/or limitations pertinent to the DMC. At 1038, the DMC can be cancelled (e.g., to prevent unauthorized duplicate redemption). At 1040, method 1000 can submit purchase data to an entity sponsoring the DMC for reimbursement of at least a portion of the redeemed value specified in the DMC. At 1042, method 1000 can terminate. As described, method 1000 provides a particular series of acts that can be implemented in conjunction with providing a DMC to one or more mobile devices utilizing a fast, efficient, and reliable P-P communication that determines a concurrent distance between the mobile devices and a DMC issuing device.

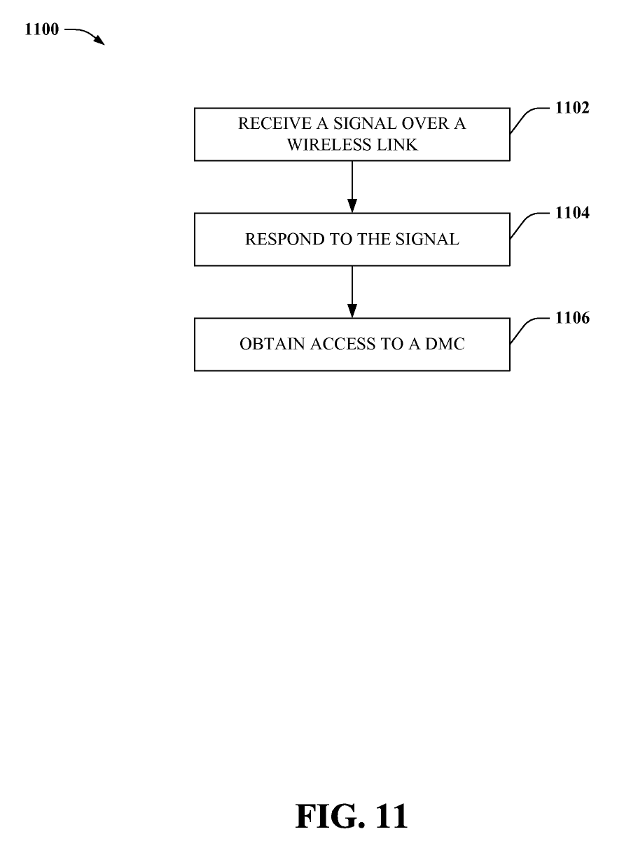

FIG. 11 provides a flowchart of an example methodology 1100 for facilitating use and redemption of a DMC in a mobile environment based on verified P-P ranging. At 1102, a signal can be received over a wireless link. The signal can include instructions pertinent to providing a response to the signal and/or a time such signal was transmitted. At 1104, a response to the signal can be sent. Such response can be in compliance with the instructions and include information identified by such instructions (e.g., receive time of the signal, data transformed according to an identified sequence or function, a turnaround time associated with sending the signal and/or transforming data, and so on). In addition, the response can be suitable to determine at least a minimum distance between two wireless communication devices. At 1106, access to a DMC can be obtained. The access can include at least a unique identifier of the DMC and an entity that can redeem the DMC. For instance, the DMC can specify a unique DMC number and a name and/or location of a retail store that can redeem the DMC. In some aspects, the access can include a description of a product and/or transaction pertinent to the DMC, commercial value provided in conjunction with such transaction/product, and/or advertisement information related to the product, a sponsoring entity, a retail entity, and/or the like. For instance, the access can include a DMC application that can provide information describing the DMC, terms, conditions, and limitations applicable to the DMC, redemption information, concurrent value of the DMC, method(s) of calculating dynamic value, and so on, as described herein. The access to the DMC is based at least in part on the verified distance between the wireless communication devices. The verified distance can help to reduce likelihood of providing access to the DMC for an unauthorized, spoofing device. Accordingly, method 1100 can provide additional security for distribution of DMCs in a P-P wireless environment.

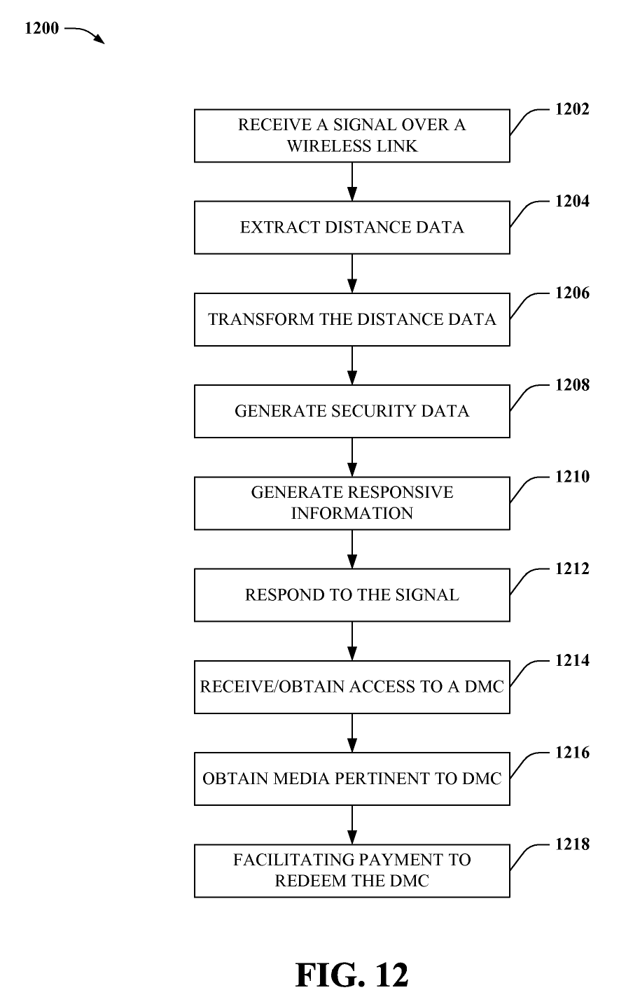

FIG. 12 depicts a flowchart of a sample methodology 1200 for facilitating distribution of a DMC in a wireless P-P environment. At 1202, a signal can be received over a wireless link. At 1204, distance data can be extracted from the wireless link. The distance data can comprise information pertinent to determining a distance between two devices based on the wireless link. For instance, the distance data can include a time of transmission of such signal. Based on the time of transmission and a time of reception, along with propagation speed of the signal in a suitable medium, distance between a sending and receiving device can be determined.

At 1206, the distance data can be transformed as specified by the signal. For instance, the signal can provide a sequence (e.g., predetermined, random, pseudo-random) for transforming the data. In other aspects, the signal can provide a function that can transform the data. Upon transforming the distance data, security data can be generated from the result of the transformed data at reference number 1208. At 1210, responsive information can be generated. The response information can include data required by a transmitting device to determine and/or verify a distance between two devices. For instance, the responsive information can include a turnaround time associated with sending a response signal and/or transforming the distance data.

At 1212, a response to the signal is sent. The response can include the distance data, transformed distance data, and/or responsive information. At 1214, access to a DMC is received or obtained. For instance, an identifier associated with a DMC can be obtained that gives a partial description of the DMC along with additional information pertinent to redeeming and/or determining further information. In other aspects, a full description of the DMC including terms, conditions, limitations, value, value conditions, and/or the like as described herein, can be received. Accordingly, based at least in part on the access, the DMC can be redeemed.

At 1216, media pertinent to the DMC can optionally be obtained. The media can provide information about the DMC, including transaction, product, value, redeeming entity, redeeming location, and so on, pertinent to redeeming the DMC. In addition, the media can provide advertisement information describing the product, a sponsoring entity, a retail store, etc. At reference number 1218, payment is facilitated in conjunction with engaging in a commercial transaction to redeem the DMC. The payment can include an electronic form of legal tender (e.g., credit/debit information, wire transfer information, etc.) for a product identified by the DMC. In addition, a value provided by the DMC can be applied to the payment. For instance, a specified discount can be subtracted from such payment to complete the transaction. As described, method 1200 can provide an efficient mechanism to increase security regarding distribution and redemption of DMC's in a wireless P-P environment.

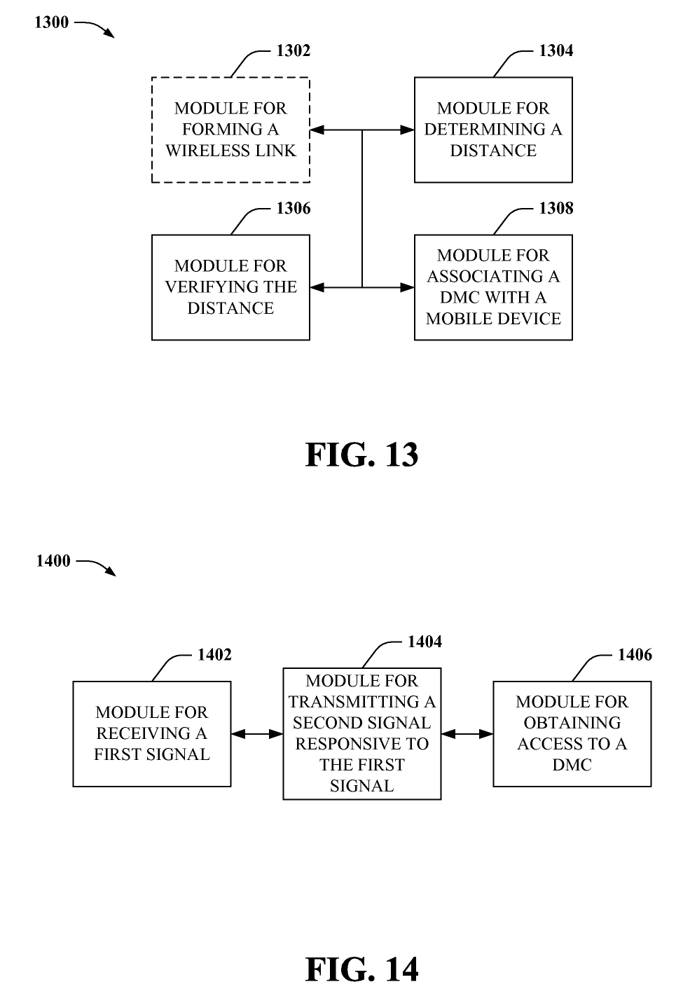

FIG. 13 depicts an example system 1300 related to providing a DMC to one or more mobile devices based at least in part on a verified distance to such devices. In some aspects, system 1300 can include a module for forming a wireless link 1302. Such module 1302 can be utilized to form a wireless link between a DMC issuing device and a mobile device, for instance. It should be appreciated, however, that the module for forming a wireless link 1302 is optional to system 1300, as indicated by the dashed lines. According to other aspects, system 1300 can communicatively couple with other devices via wired communication or like mechanisms (e.g., downloading data from portable storage). System 1300 can further including a module for determining a distance 1304 between a first device and a second device (e.g., optionally based on a wireless link established by optional module 1302). For instance, the module 1304 can send a first signal from a DMC issuing device to the mobile device. A second signal, in response to the first signal, from the mobile device can be received at module 1304, and a round trip propagation time can be applied to transmitting the first signal and receiving the second signal. Such time can be utilized to calculate the distance between such devices. In addition, a module for verifying the distance 1306 can be included with system 1300. The module 1306 can compare the distance with a minimum distance and minimum time associated with performing particular actions at the mobile device. Such actions can include sending the second signal in response to the first signal, transforming data provided or identified in the first signal, and so on. In addition to the foregoing, system 1300 can include a module for associating a DMC with the mobile device 1308. Such module can transmit the DMC or an indication thereof to the mobile device, store an ID of the mobile device with an ID of the DMC, update a status (e.g., active, redeemed, cancelled) of the DMC, and/or redeem the DMC in conjunction with an identified commercial transaction.

FIG. 14 illustrates an example system 1400 related to facilitating distribution of a DMC in a P-P ranging environment. System 1400 can include a module for receiving a first signal 1402. The module 1402 can receive such signal via a P-P wireless link with a wireless device, for instance. The signal can include information pertinent to determining and/or verifying a distance between two wireless devices (e.g., including transmission time). System 1400 can also include a module for responding to the first signal 1404. Such module 1404 can transmit a second signal in response to the first signal. The second signal can include further information pertinent to determining and/or verifying the distance. For instance, the second signal can include a time that the first signal is received and a time the second signal is transmitted. Alternatively, or in addition, the second signal can include data transformed according to a sequence and/or function specified by the first signal, along with a processing time for performing the transformation. In addition to the foregoing, system 1400 can include a module for obtaining access to a DMC 1406. Such a module 1406 can receive information pertaining to the DMC, such as an identification of the DMC, a transaction, product, and/or value associated with the DMC, information pertaining to redeeming the DMC, or terms and limitations on redeeming the DMC, or a combination thereof or of the like. The module 1406 can further redeem the DMC in conjunction with completing a transaction specified by the DMC (e.g., purchase of a product). Upon redeeming the DMC, a value specified in the DMC can be provided to the module 1406, applied to the transaction, etc.

What has been described above includes examples of one or more aspects. It is, of course, not possible to describe every conceivable combination of components or methodologies for purposes of describing the aforementioned aspects, but one of ordinary skill in the art may recognize that many further combinations and permutations of various aspects are possible. Accordingly, the described aspects are intended to embrace all such alterations, modifications, and variations that fall within the scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of wireless communication, comprising:
determining a distance between a first device and a mobile device;
determining whether the distance is equal to or less than at least one distance threshold; and
associating a dynamic mobile coupon (DMC) with the mobile device based at least in part on the at least one distance threshold determination.

2. The method of claim 1, wherein determining the distance further comprises transmitting a signal to the mobile device, wherein a characteristic of the transmitted signal provides information pertaining to determining the distance or to verifying the distance.

3. The method of claim 1, wherein determining the distance further comprises receiving a signal from the mobile device, wherein a characteristic of the received signal provides information pertaining to determining the distance or to verifying the distance.

4. The method of claim 3, further comprising at least one of:
employing a first function, random sequence, or pseudorandom sequence to transform data obtained with the received signal to verify the distance; or
providing a second function, random sequence, or pseudorandom sequence to the mobile device for transforming the data included with the received signal.

5. The method of claim 1, further comprising generating or modifying a redeemable value of the DMC based on the distance threshold determination.

6. The method of claim 1, further comprising transmitting the DMC to the mobile device.

7. The method of claim 1, further comprising transmitting an indication of the DMC to the mobile device, wherein the indication at least one of:
identifies the DMC;
identifies redemption information pertinent to the DMC; or
provides instructions for obtaining the DMC.

8. The method of claim 1, further comprising redeeming the DMC and providing a value in conjunction with purchase of a product or service identified or described by the DMC.

9. The method of claim 1, further comprising associating a cancellation flag with the DMC if the DMC is redeemed.

10. The method of claim 1, further comprising submitting data associated with the DMC and data pertaining to a product or service to an authorizing entity associated with the DMC if the DMC is redeemed.

11. The method of claim 1, further comprising associating a time dependent factor with the DMC, wherein a redeemable value associated with the DMC is subject to change based on the time dependent factor.

12. The method of claim 11, further comprising employing as part of the time dependent factor an elapsed time after associating the DMC with the mobile device, or a time of day.

13. The method of claim 1, further comprising associating a value range with the DMC based on the distance threshold determination, wherein a redeemable value associated with the DMC is subject to change within the value range based on at least one determinable factor.

14. The method of claim 13, further comprising employing as part of the determinable factor at least one of:
a number of prior redeemed coupons associated with the mobile device;
a change in the distance between the first device and the mobile device; or
a comparison of the distance and a known distance of a competitor.

15. The method of claim 1, further comprising locking the redeemable value of the DMC if the DMC is redeemed and an acceptance of the redeemable value is received from the mobile device.

16. The method of claim 15, further comprising facilitating unlocking or readjusting the redeemable value if the DMC is redeemed, based on a requirement of a DMC sponsor.

17. The method of claim 1, further comprising at least one of:
receiving instructions pertaining to a number of DMCs to distribute;
receiving instructions pertaining to a time period for distributing the number of DMCs; or
receiving instructions pertaining to a redemption deadline associated with canceling a distributed DMC.

18. The method of claim 1, further comprising at least one of:
sending the DMC to the mobile device in conjunction with media associated with a sponsor, a product or service, or a third party; or
including in the DMC a display file that comprises information pertinent to redemption of the DMC in a format configured to be displayed on the mobile device.

19. The method of claim 1, further comprising authenticating the mobile device based at least in part on verifying the distance.

20. The method of claim 1, wherein the at least one distance threshold is substantially 10 meters of less.

21. An apparatus of wireless communication, comprising:
a ranging module that determines a distance between the mobile device and the apparatus;
an authorization module that determines whether the distance is equal to or less than at least one distance threshold; and
a DMC issuance module that associates a DMC with the mobile device based at least in part on the at least one threshold distance.

22. The apparatus of claim 21, wherein the apparatus further comprises a transmitter that sends a signal to the mobile device, wherein a characteristic of the transmitted signal provides information pertaining to determining the distance or to verifying the distance.

23. The apparatus of claim 21, wherein the apparatus further comprises a receiver that receives a signal from the mobile device, wherein a characteristic of the received signal provides information pertaining to determining the distance or to verifying the distance.

24. The apparatus of claim 23, further comprising an analysis module that at least one of:
employs a first function, random sequence, or pseudorandom sequence to transform data obtained with the received signal to verify the distance; or
provides a second function, random sequence, or pseudorandom sequence to the mobile device for transforming the data included with the received signal.

25. The apparatus of claim 21, further comprising a value moderator that generates or modifies a redeemable value of the DMC based on the distance threshold determination.

26. The apparatus of claim 21, wherein the DMC issuance module initiates transmission of the DMC to the mobile device.

27. The apparatus of claim 21, wherein the DMC issuance module initiates transmission of an indication of the DMC to the mobile device, and wherein the indication at least one of:
identifies the DMC;
identifies redemption information pertinent to the DMC; or
provides instructions for obtaining the DMC.

28. The apparatus of claim 21, wherein the DMC issuance module redeems the DMC and provides a value in conjunction with purchase of a product or service identified or described by the DMC.

29. The apparatus of claim 21, further comprising a cancellation module that associates a cancellation flag at least with the DMC if the DMC is redeemed.

30. The apparatus of claim 21, further comprising a synchronization module that submits data associated with the DMC and data pertaining to a product or service to an authorizing entity associated with the DMC if the DMC is redeemed.

31. The apparatus of claim 21, further comprising a timing module that associates a time dependent factor with the DMC, wherein a redeemable value associated with the DMC is subject to change based on the time dependent factor.

32. The apparatus of claim 31, wherein the timing module employs an elapsed time after associating the DMC with the mobile device, or a time of day, as part of the time dependent factor.

33. The apparatus of claim 21, further comprising a value moderator that associates a value range with the DMC based on the distance threshold determination, wherein a redeemable value of the DMC is subject to change within the value range based on at least one determinable factor.

34. The apparatus of claim 33, wherein the value moderator employs as part of the determinable factor at least one of:
a number of prior redeemed coupons associated with the mobile device;
a change in the distance between the first device and the mobile device; or
a comparison of the distance and a known distance of a competitor.

35. The apparatus of claim 33, wherein the value moderator locks in the redeemable value of the DMC if the DMC is redeemed and an acceptance of the redeemable value is received from the mobile device.

36. The apparatus of claim 35, wherein the value moderator facilitates unlocking or readjusting the locked redeemable value based on a requirement of a DMC sponsor if the DMC is redeemed.

37. The apparatus of claim 21, further comprising a sponsor database that includes at least one of:
instructions pertaining to a number of DMCs to distribute;
instructions pertaining to a time period for distributing the number of DMCs; or
instructions pertaining to a redemption deadline associated with canceling a distributed DMC.

38. The apparatus of claim 21, further comprising an integration module that at least one of:
includes an advertisement or media associated with a sponsor, a product or service, or a third party with a DMC and facilitates transmission of the DMC and advertisement or media to the mobile device; or
includes a display file in the DMC that comprises information pertinent to redemption of the DMC, wherein the display file is in a format configured to be displayed on the mobile device.

39. The apparatus of claim 21, further comprising a security module that authenticates the mobile device with the host device based in part on the verified distance.

40. The apparatus of claim 21, wherein the at least one threshold distance is substantially 10 meters or less.

41. A DMC host device, comprising:
a ranging module configured to determine a distance between the DMC host device and a mobile device;
an authorization module configured to determine whether the distance is equal to or less than at least one distance threshold;
a DMC issuance module configured to associate a DMC with the mobile device based at least in part on the at least one threshold distance determination; and
a synchronization module configured to associate the DMC with a transaction.

42. An apparatus for wireless communication, comprising:
means for determining a distance between a first device and a mobile device;
means for determining whether the distance is equal to or less than at least one distance threshold; and
means for associating a DMC with the mobile device based at least in part on the distance threshold determination.

43. The apparatus of claim 42, further comprising at least one of:
means for transmitting at least a first signal to the mobile device, wherein a characteristic of the first signal provides information pertaining to determining the distance or to verifying the distance; or
means for receiving at least a second signal from the mobile device, wherein a characteristic of the second signal provides information pertaining to determining the distance or to verifying the distance.

44. The apparatus of claim 42, further comprising generating or modifying a redeemable value of the DMC based on the distance threshold determination.

45. The apparatus of claim 42, further comprising means for associating a value range with the DMC based on the distance threshold determination, wherein a redeemable value associated with the DMC is subject to change within the value range based on at least one determinable factor.

46. The apparatus of claim 42, further comprising at least one of:
means for sending the DMC to the mobile device in conjunction with media associated with a sponsor, a product or service, or a third party; or
means for including in the DMC a display file that comprises information pertinent to redemption of the DMC in a format configured to be displayed on the mobile device.

47. The apparatus of claim 42, further comprising means for authenticating the mobile device based at least in part on verifying the distance.

48. A computer program product for wireless communication, comprising:
computer-readable medium comprising:
at least one instruction for causing a computer to determine a distance between a first device and a mobile device;
at least one instruction for causing a computer to determine whether the distance is equal to or less than at least one distance threshold; and
at least one instruction for causing a computer to associate a DMC with the mobile device based at least in part on the distance threshold determination.

49. A method of wireless communication, comprising:
receiving a first signal pertaining to a DMC;
transmitting a second signal from a first device to a second device, the second signal provides information in response to the first signal; and
obtaining access to the DMC based at least in part on a distance between the first and second devices, wherein the distance is determined at least in part from the first signal and the information provided by the second signal

50. The method of claim 49, further comprising generating the information in response to the first signal based on instructions that are at least one of:
specified by the first signal;
predefined at the first device; or
dynamically established at least in part by the first signal and the second signal.

51. The method of claim 49, further comprising applying a function to data received with the first signal to generate, at least in part, the information in response to the first signal.

52. The method of claim 49, further comprising applying a random sequence to modify data received with the first signal to generate, at least in part, the information in response to the first signal.

53. The method of claim 49, further comprising obtaining media that provides information pertinent to the DMC, a value of the DMC, a product or service, an entity sponsoring the DMC, or instructions for redeeming the DMC.

54. The method of claim 53, further comprising playing the media at the first device to present details pertaining to the DMC.

55. The method of claim 53, further comprising obtaining input that quantifies the value of the DMC among a range of potential value quantities.

56. The method of claim 49, further comprising presenting the DMC to the second device, or a device affiliated with the second device, to redeem the DMC.

57. The method of claim 56, further comprising presenting payment to the second device or the affiliated device for a product or service identified by the DMC, the payment is adjusted at least in part by the value of the DMC.

58. The method of claim 49, further comprising providing security information pertaining to the first device in response to receiving the first signal.

59. The method of claim 58, further comprising employing at least one of the distance between the first device and the second device, a public key, a private key, a digital signature, a password, or a random number as the security information.

60. An apparatus for wireless communication, comprising:
a receiver configured to receive a first signal pertaining to a DMC;
a transmitter configured to transmit a second signal to another device, the second signal provides information in response to the first signal; and
an interface module configured to obtain access to the DMC based at least in part on a distance between the apparatus and said another device, the distance is determined at least in part from the first signal and the information provided by the second signal.

61. The apparatus of claim 60, further comprising a DMC processor that generates the information in response to the first signal based on instructions that are at least one of:
specified by the first signal;
stored at the apparatus; or
dynamically established at least in part by the first signal and the second signal.

62. The apparatus of claim 60, further comprising an operating module that applies a function to data received with the first signal to generate, at least in part, the information in response to the first signal.

63. The apparatus of claim 62, wherein the operating module further applies a random sequence to modify data received with the first signal to generate, at least in part, the information in response to the first signal.

64. The apparatus of claim 60, wherein the receiver further obtains media that provides information pertinent to the DMC, a value of the DMC, a product or service, an entity sponsoring the DMC, or instructions for redeeming the DMC.

65. The apparatus of claim 64, further comprising a playback module that plays the media at the apparatus to present details pertaining to the DMC.

66. The apparatus of claim 64, further comprising a user interface that obtains input that quantifies the value of the DMC among a range of potential value quantities.

67. The apparatus of claim 60, wherein the interface module presents the DMC to said another device, or a device affiliated with said another device, to redeem the DMC.

68. The apparatus of claim 67, wherein the apparatus facilitates payment for a product or service identified by the DMC, the payment is adjusted at least in part by the value of the DMC.

69. The apparatus of claim 60, further comprising an authorization module that provides security information pertaining to the apparatus in response to receiving the first signal.

70. The apparatus of claim 69, wherein the security information includes at least one of the distance between the apparatus and said another device, a public/private key, a digital signature, a password, or a random number as the security information.

71. A mobile device, comprising:
a receiver configured to receive a first signal pertaining to a DMC;
a transmitter configured to transmit a second signal to another device, the second signal provides information in response to the first signal;
an interface module configured to obtain access to the DMC based at least in part on a distance between the mobile device and said another device, the distance is determined at least in part from the first signal and the information provided by the second signal; and
a user interface configured to provide an indication associated with the DMC or information pertinent to the DMC.

72. An apparatus for wireless communication, comprising:
means for receiving a first signal pertaining to a DMC;
means for transmitting a second signal to another device, the second signal provides information in response to the first signal; and
means for obtaining access to the DMC based at least in part on a distance between the apparatus and said another device, the distance is determined at least in part from the first signal and the information provided by the second signal.

73. The apparatus of claim 72, further comprising means for applying a function to data received with the first signal to generate, at least in part, the information in response to the first signal.

74. The apparatus of claim 72, further comprising means for applying a random sequence to modify data received with the first signal to generate, at least in part, the information in response to the first signal.

75. The apparatus of claim 72, further comprising means for obtaining media that provides information pertinent to the DMC, a value of the DMC, a product or service, an entity sponsoring the DMC, or instructions for redeeming the DMC.

76. The apparatus of claim 72, further comprising means for obtaining input that quantifies the value of the DMC among a range of potential value quantities.

77. The apparatus of claim 72, further comprising means for presenting the DMC to said another device, or a device affiliated with said another device, to redeem the DMC.

78. A computer program product to facilitate wireless communication, comprising:
computer-readable medium comprising:
at least one instruction for causing a computer to receive a first signal pertaining to a DMC;
at least one instruction for causing a computer to transmit a second signal from a first device to a second device, the second signal provides information in response to the first signal; and
at least one instruction for causing a computer to obtain access to the DMC based at least in part on a distance between the first and second devices, wherein the distance is determined at least in part from the first signal and the information provided by the second signal.
